(19) United States
(12) Patent Application Publication
(10) Pub. No.: US 2026/0287729 A1
(43) Pub. Date: Sep. 24, 2026

(54) DISAMBIGUATION OF MULTIPLE OBJECTS IN RADAR DATA

(71) Applicant: Texas Instruments Incorporated, Dallas, TX (US)

(72) Inventors: Sai Ashwith Dharoor, Gadwal (IN); Sandeep Rao, Bangalore (IN)

(21) Appl. No.: 19/373,413

(22) Filed: Oct. 29, 2025

(30) Foreign Application Priority Data
Mar. 24, 2025 (IN) 202541026895

(51) Int. Cl. G01S 13/58; G01S 7/295; G01S 13/931

(52) U.S. Cl. CPC G01S 13/581; G01S 7/295; G01S 13/931; G01S 2013/93271; G01S 2013/93272; G01S 2013/93274

(57) ABSTRACT

An example device includes a memory configurable to store radar data. The device includes a programmable circuit coupled to the memory and configurable to: estimate a first angle of a first object using the radar data, estimate a second angle of a second object using the radar data, select a first angle bin and a second angle bin using the estimated first angle and the estimated second angle, perform doppler disambiguation for the first angle bin, and perform doppler disambiguation for the second angle bin. Other examples are described.

### CROSS-REFERENCE TO RELATED APPLICATION

This patent application claims the benefit of and priority to Indian Provisional Patent Application No. 202541026895 filed Mar. 24, 2025, which is hereby incorporated herein by reference in its entirety.

### TECHNICAL FIELD

This description relates generally to radar disambiguation and, more particularly, to disambiguation of multiple objects in radar data.

### BACKGROUND

Doppler division multiple-access (DDMA) is a method of dividing a Doppler dimension or Doppler domain into multiple sub-divisions and assigning a transmitter to one sub-division. This may be performed by generating a sequence of chirps such that there is a linear increment (or decrement) in the starting phase of each chirp. Different transmitters may have different rates of phase increment or decrement. For each chirp, multiple transmitters are enabled. When received and processed according to a two-dimensional fast Fourier transform (FFT), DDMA signals from different transmitters will each occupy a different band in the Doppler domain. In this way, DDMA facilitates the simultaneous use of multiple transmitters within a single chirp while preventing the multiple transmitters from interfering with each other in the Doppler domain, also providing a capability to separate data from each transmitter.

### SUMMARY

For disambiguation of multiple objects in radar data, an example device includes a memory configurable to store radar data. The device includes a programmable circuit coupled to the memory and configurable to: estimate a first angle of a first object using the radar data, estimate a second angle of a second object using the radar data, select a first angle bin and a second angle bin using the estimated first angle and the estimated second angle, perform doppler disambiguation for the first angle bin, and perform doppler disambiguation for the second angle bin. Other examples are described.

For disambiguation of multiple objects in radar data, an example method includes estimating a first angle of a first object using radar signals. The method includes estimating a second angle of a second object using the radar signals. The method includes selecting a first angle bin and a second angle bin using the estimated first angle and the estimated second angle. The method includes performing doppler disambiguation for the first angle bin. The method includes performing doppler disambiguation for the second angle bin. Other examples are described.

For disambiguation of multiple objects in radar data, an example system includes a plurality of radar receivers configurable to receive radar signals reflected from a first object and a second object. The system includes a programmable circuit coupled to the plurality of radar receivers and configurable to: estimate a first angle of the first object using the radar signals, estimate a second angle of the second object using the radar signals, select a first angle bin and a second angle bin using the estimated first angle and the estimated second angle, perform doppler disambiguation for the first angle bin, and perform doppler disambiguation for the second angle bin. Other examples are described.

### BRIEF DESCRIPTION OF THE DRAWINGS

FIG. 1 is a block diagram of an example radar system including example radar circuits.

FIG. 2A is a timing diagram of an example frame of example chirps.

FIG. 2B is a diagram of an example Doppler domain spectrum of a received frame of reflected chirps.

FIG. 3 is a diagram of an example Doppler domain spectrum of a received frame of reflected chirps transmitted by three transmitters implementing DDMA.

FIG. 4A is a diagram of a first example mapping of three example transmitters of a radar circuit to the Doppler domain spectrum of FIG. 3.

FIG. 4B is a diagram of a second example mapping of the three transmitters to the Doppler domain spectrum of FIG. 3.

FIG. 4C is a diagram of a third example mapping of the three transmitters to the Doppler domain spectrum of FIG. 3.

FIG. 5A is a diagram of a first example mapping of three example transmitters of a radar circuit to an example Doppler domain spectrum of a received frame of reflected chirps transmitted by the three transmitters when implementing DDMA with a single empty band.

FIG. 5B is a diagram of a second example mapping of the three transmitters to the Doppler domain spectrum of the received frame of reflected chirps transmitted by the three transmitters when implementing DDMA with a single empty band.

FIG. 5C is a diagram of a third example mapping of the three transmitters to the Doppler domain spectrum of the received frame of reflected chirps transmitted by the three transmitters when implementing DDMA with a single empty band.

FIG. 5D is a diagram of a fourth example mapping of the three transmitters to the Doppler domain spectrum of the received frame of reflected chirps transmitted by the three transmitters when implementing DDMA with a single empty band.

FIG. 6A is a diagram of an example Doppler domain spectrum of a received frame of reflected chirps transmitted by four example transmitters implementing DDMA with two contiguous empty bands and four contiguous occupied bands.

FIG. 6B is a diagram of an example Doppler domain spectrum of a received frame of reflected chirps transmitted by four example transmitters implementing DDMA with at least two non-contiguous empty bands.

FIG. 7 is a graphical illustration of how the empty bands of a first example Doppler domain spectrum and a second example Doppler domain spectrum are eliminated when the objects corresponding to the first Doppler domain spectrum and the second Doppler domain spectrum are at the same range with offset velocities.

FIG. 8 is a block diagram of an example radar transceiver integrated circuit (IC) that can implement any of the radar circuits of FIG. 1.

FIG. 9 is a diagram of an example processing flow to disambiguate a first object and a second object detected in radar data.

FIG. 10 is a diagram of an example processing flow to determine whether to perform the processing flow of FIG. 9.

FIG. 11A is a diagram of an example processing flow to perform coarse angle estimation at the first process of FIG. 9.

FIG. 11B is a diagram of another example processing flow to perform coarse angle estimation at the first process of FIG. 9.

FIG. 12A is a diagram of an example processing flow to perform transmitter disambiguation for multiple objects at the second process of FIG. 9.

FIG. 12B is a diagram of a first example graph and a second example graph illustrating two techniques for choosing the threshold value (δ) of FIG. 12A.

FIG. 13 is a diagram of an example graph comparing the probability of correctly disambiguating transmitters with non-contiguous empty bands in the presence of band collision as described herein.

FIG. 14A is a diagram of an example graph illustrating the estimated angle of objects with respect to the radar transceiver IC for different angle estimation techniques.

FIG. 14B is a diagram of an example graph illustrating the estimated angle of objects with respect to the radar transceiver IC for different angle estimation techniques.

FIG. 15 is a flowchart representative of at least one of example machine-readable instructions or example operations that may be at least one of executed, instantiated, or performed using an example programmable circuitry implementation of the radar transceiver IC of FIG. 8.

FIG. 16 is a flowchart representative of at least one of example machine-readable instructions or example operations that may be at least one of executed, instantiated, or performed using an example programmable circuitry implementation of the radar transceiver IC of FIG. 8 to perform band collision transmitter disambiguation.

FIG. 17 is a block diagram of an example processing platform including programmable circuitry structured to execute, instantiate, or perform the at least one of the example machine-readable instructions or the example operations of FIGS. 15 and 16 to implement the radar transceiver IC of FIG. 8.

The drawings are not necessarily to scale. Generally, the same reference numbers in the drawing(s) and this description refer to the same or similar (in terms of at least one of functional or structural) features or parts.

### DETAILED DESCRIPTION

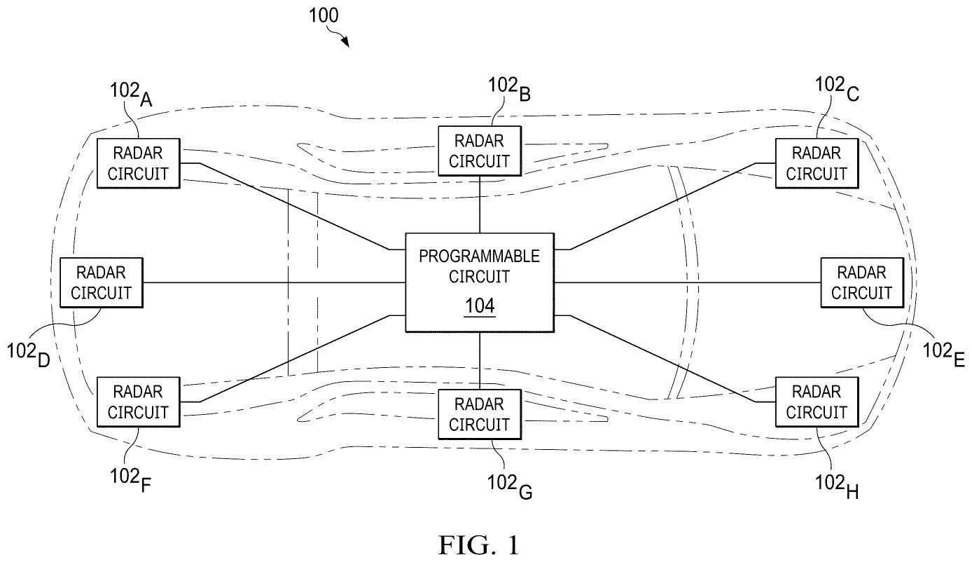

FIG. 1 is a block diagram of an example radar system 100 including example radar circuits 102_{A}-102_{H}. In the example of FIG. 1, the radar system 100 also includes an example programmable circuit 104. In the example of FIG. 1, one or more of the radar circuits 102_{A}-102_{H} may be referred to as a radar front end, and the programmable circuit 104 may be referred to as a radar backend. In some examples, one or more of the radar circuits 102_{A}-102_{H} and the programmable circuit 104 are implemented separately and may be configurable to be coupled together. Also or alternatively, one or more of the radar circuits 102_{A}-102_{H} is implemented with an instance of the programmable circuit 104, for example, in a single chip package or on a system-on-chip (SoC) (such as a single integrated circuit). In examples in which one or more of the radar circuits 102_{A}-102_{H} are implemented with an instance of the programmable circuit 104 on a SoC, the one or more of the radar circuits 102_{A}-102_{H} may correspond to a sub-circuit of the integrated circuit (IC) that forms the SoC.

In the illustrated example of FIG. 1, the programmable circuit 104 is coupled to each of the radar circuits 102_{A}-102_{H} (for example, via an interface) that may facilitate any suitable communication technique (such as a serial interface, a parallel interface, etc.) and is configured to at least one of receive data from or transmit data to each of the radar circuits 102_{A}-102_{H}. In some examples, the interface between the programmable circuit 104 and each of the radar circuits 102_{A}-102_{H} may be a high-speed serial interface such as a low-voltage differential signaling (LVDS) interface. Also or alternatively, the interface between the programmable circuit 104 and each of the radar circuits 102_{A}-102_{H} may be a lower speed interface such as a serial peripheral interface (SPI).

In the illustrated example of FIG. 1, each of the radar circuits 102_{A}-102_{H} includes functionality to generate one or more chirp signals as described herein. In the example of FIG. 1, each of the radar circuits 102_{A}-102_{H} also includes functionality to generate one or more digital intermediate frequency (IF) signals (sometimes referred to as de-chirped signals, beat signals, or raw radar signals) from reflected chirps. Also, each of the radar circuits 102_{A}-102_{H} includes functionality to perform at least a portion of signal processing of received radar signals (for example, the reflected chirps, the digital IF signals, etc.), and to provide the results of the signal processing to the programmable circuit 104. In some examples, each of the radar circuits 102_{A}-102_{H} includes functionality to perform a range FFT for each received frame (for example, each sequence of chirps of the frame). Also or alternatively, each of the radar circuits 102_{A}-102_{H} includes functionality to perform a Doppler FFT for each received frame (for example, after performing, and on a result of, the range FFTs).

In the illustrated example of FIG. 1, the programmable circuit 104 includes functionality to process data received from one or more of the radar circuits 102_{A}-102_{H} to, for example, determine one or more of a distance, velocity, or angle of any objects detected by the radar system 100. Also or alternatively, the programmable circuit 104 includes functionality to perform post processing of information concerning the detected objects, such as tracking objects or determining rate and direction of movement. In some examples, the programmable circuit 104 performs at least one of velocity disambiguation or collision detection. For example, according to aspects of the present description, at least one of velocity disambiguation or collision detection is facilitated by disambiguating between multiple objects represented in the same Doppler spectrum (for example, multiple objects represented in an output signal of a Doppler FFT performed on a received frame).

In the illustrated example of FIG. 1, the programmable circuit 104 includes one or more processors or combinations of processors for processing data received from one or more of the radar circuits 102_{A}-102_{H}. In the example of FIG. 1, the programmable circuit 104 also provides data to one or more of the radar circuits 102_{A}-102_{H}. For example, the programmable circuit 104 may include one or more of a digital signal processor (DSP), a microcontroller, a SoC combining both a DSP and a microcontroller, a field-programmable gate array (FPGA), or any combination of the foregoing.

In the illustrated example of FIG. 1, the radar system 100 can be implemented in a variety of applications such as advanced driver assistance systems (ADAS) and automotive vehicles to measure distance, velocity, acceleration, and angle. In some examples, the radar system 100 can be implemented in other vehicles (such as aircraft or marine military or civilian vehicles), industrial use-cases (such as factory automation), satellites, imaging radar, robotics, building automation, security and surveillance, consumer electronics use-cases, or medical devices for blood pressure monitoring, emotional monitoring, and sleep monitoring. In the example of FIG. 1, the radar system 100 is implemented in an example automotive application. For example, the radar circuits 102_{A}-102_{H} are positioned around a vehicle to provide automotive driver assistance. FIG. 1 shows an example use-case with eight radar circuits, while some vehicles may have only corner radar circuits 102_{A}, 102_{C}, 102_{F}, 102_{H} and/or front radar circuit 102E.

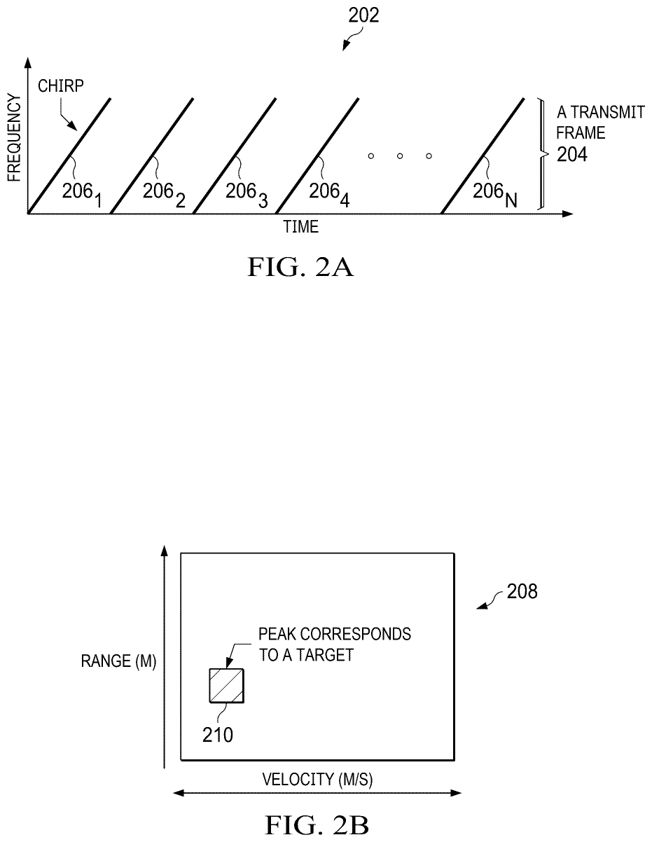

In the illustrated example of FIG. 1, one or more of the radar circuits 102_{A}-102_{H} can implement DDMA as described herein. For example, one or more of the radar circuits 102_{A}-102_{H} can generate, and transmit into an environment, a sequence of chirps, sometimes referred to as a frame of chirps, such that there is a linear increment (or decrement) in the starting phase of each chirp. FIG. 2A is a timing diagram 202 of an example frame 204 of example chirps 2061-206N.

In the illustrated example of FIG. 2A, the timing diagram 202 depicts frequency versus time. As illustrated in FIG. 2A, a chirp is a signal where the frequency of the signal varies linearly with time. In the example of FIG. 2A, the frame 204 refers to a series of (for example, N) chirps that are equidistantly spaced in time. As such, in some examples, the frame 204 is referred to as a frequency modulated continuous wave (FMCW) frame. In the example of FIG. 2A, the frame 204 includes a linear increment (or decrement) in phase of each chirp of the frame 204. As such, the phase change between consecutive chirps of the frame 204 is equal (for example, ΔΦ_{C1-C2}=ΔΦ_{C2-C3}=ΔΦ_{C3-C4} . . . =ΔΦ_{C(N-1)-CN}).

When the frame 204 of the chirps 2061-206N is transmitted into an environment and reflected off an object, a received frame may be processed according to a two-dimensional FFT and represented in the Doppler domain. FIG. 2B is a diagram of an example Doppler domain spectrum 208 of a received frame of reflected chirps. To generate the Doppler domain spectrum 208 (sometimes referred to as a range-Doppler heatmap), a radar circuit can process a received frame of reflected chirps across the multiple reflected chirps. In the example of FIG. 2B, the Doppler domain spectrum 208 is a three-dimensional graph that depicts range in meters (m) versus velocity in meters per second (m/s) where signals in the two-dimensional range-velocity field have an associated magnitude providing a third dimension. Signal peaks in the Doppler domain spectrum 208 correspond to targets in a field of view of a radar circuit. For example, the Doppler domain spectrum 208 includes an example representation 210 of an object in a field of view of a radar circuit.

In modern applications, radar circuits include multiple transmitters and multiple receivers. DDMA provides a method to divide the Doppler domain spectrum into multiple sub-divisions and assign each of the multiple transmitters to a respective sub-division. For example, DDMA is widely used in automotive FMCW radar applications. In DDMA, multiple transmitters transmit a frame of chirps simultaneously where each transmitter imparts a linear phase change (Φ) across the chirps of the frame as described above. For the k^{th} indexed transmitter,

$${Φ}_{k} = \frac{2 π k}{{N}_{TX}}$$

where N_{TX} is the number of transmitters and k is an index value in a range of [0:N−1] corresponding to a transmitter that will be transmitting a signal with a phase change Φₖ. As such, the phase changes for the N_{TX} transmitters increase linearly with a direct proportionality to transmitter indices. DDMA results in the Doppler domain spectrum being divided into N_{TX} bands where each target detected by a radar circuit results in Nix peaks or representations and each peak (also referred to as an image) corresponds to one of the NIX transmitters.

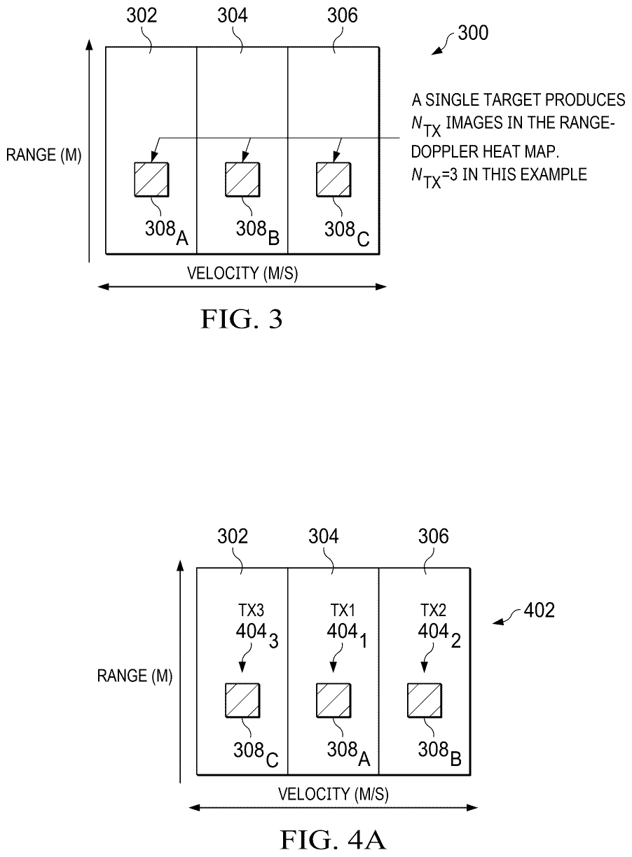

FIG. 3 is a diagram of an example Doppler domain spectrum 300 of a received frame of reflected chirps transmitted by three transmitters implementing DDMA. In the example of FIG. 3, the origin of the velocity axis of the Doppler domain spectrum 300 is in the middle of the velocity axis. As such, values to the left of the origin of the velocity axis are less than the value of the origin (for example, zero) and values to the right of the origin of the velocity axis are greater than the value of the origin. In the example of FIG. 3, the Doppler domain spectrum 300 includes a first example band 302, a second example band 304, and a third example band 306.

In the illustrated example of FIG. 3, each of the bands of the Doppler domain spectrum 300 includes a representation of an object (sometimes referred to as a target) that reflected chirps transmitted into an environment. For example, the first band 302 includes a first example representation 308_{A} of the object, the second band 304 includes a second example representation 308_{B} of the object, and the third band 306 includes a third example representation 308_{C} of the object. Also, the representation of the object in each band corresponds to one of the transmitters that transmitted the chirps into the environment.

As illustrated in FIG. 3, DDMA signals from different transmitters will each occupy different bands in the Doppler domain spectrum. In this way, DDMA facilitates the simultaneous use of multiple transmitters with a single chirp while preventing the multiple transmitters from interfering with each other in the Doppler domain. Mapping each of the transmitters to a corresponding band of a Doppler representation of received data (for example, identifying which transmitter corresponds to which band) is important for post processing of received data (for example, to determine velocity, to determine angle of arrival, etc.).

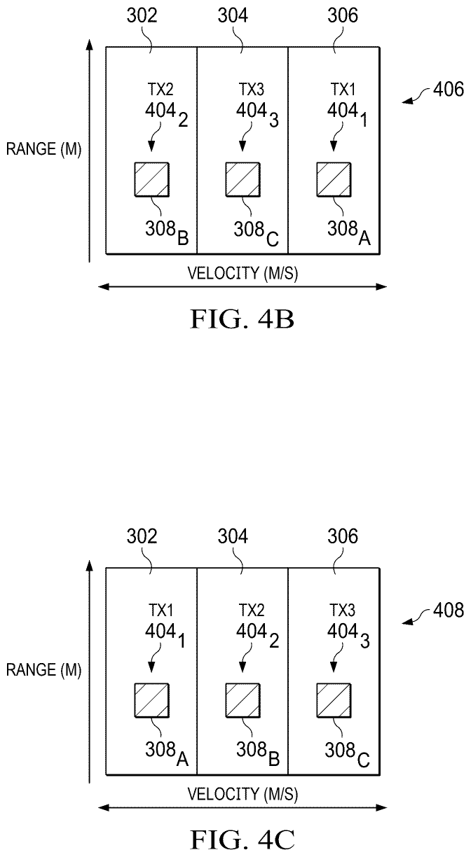

However, the mapping of transmitters to representations of an object depends on the velocity of a target, which may be unknown at the time mapping is performed. As such, there are multiple potential mappings for a given number of transmitters. For example, FIG. 4A is a diagram of a first example mapping 402 of three example transmitters 404₁-404₃ of a radar circuit to the Doppler domain spectrum 300 of FIG. 3.

In the illustrated example of FIG. 4A, the first representation 308_{A} corresponds to an example first indexed transmitter 404₁ of the radar circuit and the first indexed transmitter 404₁ is mapped to the second band 304 of the Doppler domain spectrum 300. For example, a radar circuit may include an array of transmitters and an array of receivers where each transmitter of the array of transmitters and each receiver of the array of receivers is assigned an index (for example, ranging from 0 to N−1, from 1 to N, etc.). As such, indices increase consecutively from an initial index (for example, a zero indexed transmitter is followed by a first indexed transmitter, a first indexed transmitter is followed by a second indexed transmitter, etc.).

In the illustrated example of FIG. 4A, the second representation 308_{B} corresponds to an example second indexed transmitter 404₂ of the radar circuit and the second indexed transmitter 404₂ is mapped to the third band 306 of the Doppler domain spectrum 300. In the example of FIG. 4A, the third representation 308_{C} corresponds to an example third indexed transmitter 404₃ of the radar circuit and the third indexed transmitter 404₃ is mapped to the first band 302 of the Doppler domain spectrum 300. If the three transmitters 404₁-404₃ are mapped to the Doppler domain spectrum 300 according to the first mapping 402, then a radar circuit can determine that the velocity of the target is between negative V_{MAX}/3 and V_{MAX}/3.

FIG. 4B is a diagram of a second example mapping 406 of the three transmitters 404₁-404₃ to the Doppler domain spectrum 300 of FIG. 3. In the example of FIG. 4B, the first representation 308_{A} corresponds to the first indexed transmitter 404₁ of the radar circuit and the first indexed transmitter 404₁ is mapped to the third band 306 of the Doppler domain spectrum 300. Also, in the example of FIG. 4B, the second representation 308_{B} corresponds to the second indexed transmitter 404₂ of the radar circuit and the second indexed transmitter 404₂ is mapped to the first band 302 of the Doppler domain spectrum 300. In the example of FIG. 4B, the third representation 308_{C} corresponds to the third indexed transmitter 404₃ of the radar circuit and the third indexed transmitter 404₃ is mapped to the second band 304 of the Doppler domain spectrum 300. If the three transmitters 404₁-404₃ are mapped to the Doppler domain spectrum 300 according to the second mapping 406, then a radar circuit can determine that the velocity of the target is between V_{MAX}/3 and V_{MAX}.

FIG. 4C is a diagram of a third example mapping 408 of the three transmitters 404₁-404₃ to the Doppler domain spectrum 300 of FIG. 3. In the example of FIG. 4C, the first representation 308_{A} corresponds to the first indexed transmitter 404₁ of the radar circuit and the first indexed transmitter 404₁ is mapped to the first band 302 of the Doppler domain spectrum 300. Also, in the example of FIG. 4C, the second representation 308_{B} corresponds to the second indexed transmitter 404₂ of the radar circuit and the second indexed transmitter 404₂ is mapped to the second band 304 of the Doppler domain spectrum 300. In the example of FIG. 4C, the third representation 308_{C} corresponds to the third indexed transmitter 404₃ of the radar circuit and the third indexed transmitter 404₃ is mapped to the third band 306 of the Doppler domain spectrum 300. If the three transmitters 404₁-404₃ are mapped to the Doppler domain spectrum 300 according to the third mapping 408, then a radar circuit can determine that the velocity of the target is between negative V_{MAX} and negative V_{MAX}/3.

As illustrated in FIGS. 4A-4C, disambiguating between received data presents a challenge and is important for post processing of received data. Disambiguation is especially important in operating environments with interfering signals, such as automotive radar where many vehicles are transmitting in the same frequency band. Each vehicle's radar system can perform better object detection if the system can distinguish reflections of its own transmitted signals from the signals transmitted by other vehicles' radars and from the multipath reflections of its own transmitted signals. One approach to perform DDMA disambiguation is to control transmitters of a radar circuit to transmit signals with respective phase changes. Responsive to the respective phase changes of the transmitted signals, one or more contiguous empty bands occur in the Doppler domain. In DDMA with one or more contiguous empty bands, multiple transmitters transmit a frame of chirps simultaneously where each transmitter imparts a linear phase change (Φ) across the chirps of the frame as described above. For the k^{th} indexed transmitter,

$${Φ}_{k} = \frac{2 π k}{{N}_{TX} + {N}_{EB}}$$

where N_{TX} is the number of transmitters, N_{EB} is the number of contiguous empty bands, and k is an index value in a range of [0:N−1] corresponding to a transmitter that will be transmitting a signal with a phase change Φₖ. As such, the phase changes for the N_{TX} transmitters increase linearly with a direct proportionality to transmitter indices. DDMA with one or more contiguous empty bands results in the Doppler domain spectrum being divided into the sum of N_{TX} and N_{EB} bands with N_{EB} bands being contiguous and empty (for example, lacking a representation of the target). Also, each target detected by a radar circuit results in N_{TX} peaks or representations and each peak (also referred to as an image) corresponds to one of the N_{TX} transmitters as in DDMA.

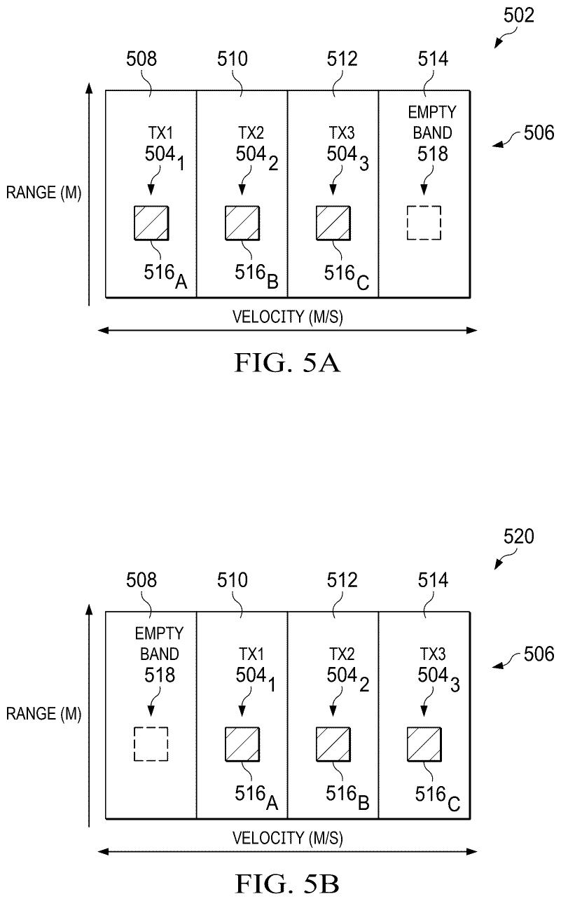

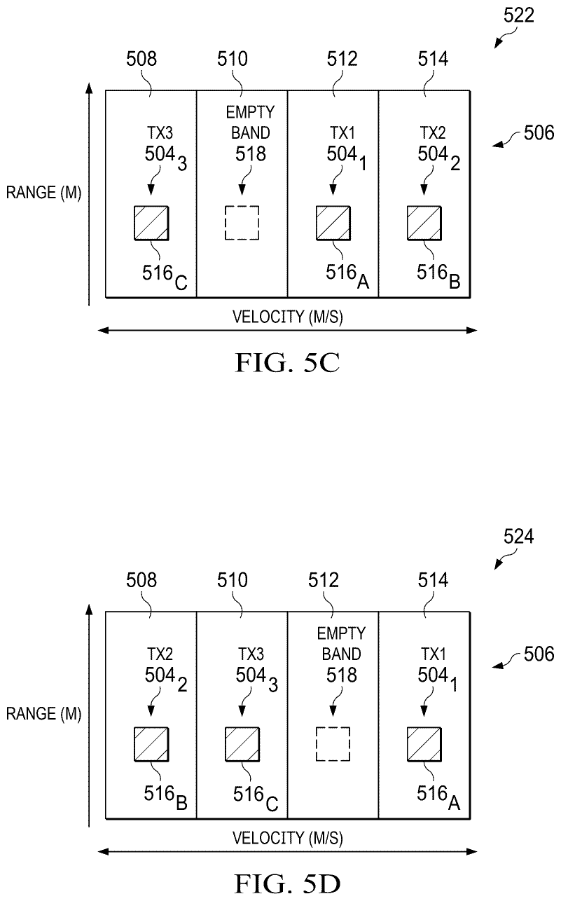

FIG. 5A is a diagram of a first example mapping 502 of three example transmitters 504₁-504₃ of a radar circuit to an example Doppler domain spectrum 506 of a received frame of reflected chirps transmitted by the three transmitters 504₁-504₃ when implementing DDMA with a single empty band. In the example of FIG. 5A, the Doppler domain spectrum 506 includes a first example band 508, a second example band 510, a third example band 512, and a fourth example band 514. Also, some of the bands of the Doppler domain spectrum 506 include a representation of an object that reflected chirps transmitted into an environment.

In the illustrated example of FIG. 5A, the representation of the object in some of the bands corresponds to one of the transmitters that transmitted the chirps into the environment. According to the first mapping 502 of FIG. 5A, an example first indexed transmitter 504₁ of the radar circuit is mapped to the first band 508 of the Doppler domain spectrum 506 and corresponds to a first example representation 516A of the object. In the example of FIG. 5A, an example second indexed transmitter 504₂ of the radar circuit is mapped to the second band 510 of the Doppler domain spectrum 506 and corresponds to a second example representation 516B of the object.

In the illustrated example of FIG. 5A, an example third indexed transmitter 504₃ of the radar circuit is mapped to the third band 512 of the Doppler domain spectrum 506 and corresponds to a third example representation 516_{C} of the object. Also, the fourth band 514 of the Doppler domain spectrum 506 is mapped to an example empty band 518. If the three transmitters 504₁-504₃ and the empty band 518 are mapped to the Doppler domain spectrum 506 according to the first mapping 502, then a radar circuit can determine that the velocity of the target is between negative V_{MAX} and negative V_{MAX}/2.

FIG. 5B is a diagram of a second example mapping 520 of the three transmitters 504₁-504₃ to the Doppler domain spectrum 506 of the received frame of reflected chirps transmitted by the three transmitters 504₁-504₃ when implementing DDMA with a single empty band. According to the second mapping 520 of FIG. 5B, the first indexed transmitter 504₁ of the radar circuit is mapped to the second band 510 of the Doppler domain spectrum 506 and corresponds to the first representation 516A of the object. In the example of FIG. 5B, the second indexed transmitter 504₂ of the radar circuit is mapped to the third band 512 of the Doppler domain spectrum 506 and corresponds to the second representation 516B of the object.

In the illustrated example of FIG. 5B, the third indexed transmitter 504₃ of the radar circuit is mapped to the fourth band 514 of the Doppler domain spectrum 506 and corresponds to the third representation 516_{C} of the object. Also, the first band 508 of the Doppler domain spectrum 506 is mapped to the empty band 518. If the three transmitters 504₁-504₃ and the empty band 518 are mapped to the Doppler domain spectrum 506 according to the second mapping 520, then a radar circuit can determine that the velocity of the target is between negative V_{MAX}/2 and zero.

FIG. 5C is a diagram of a third example mapping 522 of the three transmitters 504₁-504₃ to the Doppler domain spectrum 506 of the received frame of reflected chirps transmitted by the three transmitters 504₁-504₃ when implementing DDMA with a single empty band. According to the third mapping 522 of FIG. 5C, the first indexed transmitter 504₁ of the radar circuit is mapped to the third band 512 of the Doppler domain spectrum 506 and corresponds to the first representation 516A of the object. In the example of FIG. 5C, the second indexed transmitter 504₂ of the radar circuit is mapped to the fourth band 514 of the Doppler domain spectrum 506 and corresponds to the second representation 516B of the object.

In the illustrated example of FIG. 5C, the third indexed transmitter 504₃ of the radar circuit is mapped to the first band 508 of the Doppler domain spectrum 506 and corresponds to the third representation 516_{C} of the object. Also, the second band 510 of the Doppler domain spectrum 506 is mapped to the empty band 518. If the three transmitters 504₁-504₃ and the empty band 518 are mapped to the Doppler domain spectrum 506 according to the third mapping 522, then a radar circuit can determine that the velocity of the target is between zero and V_{MAX}/2.

FIG. 5D is a diagram of a fourth example mapping 524 of the three transmitters 504₁-504₃ to the Doppler domain spectrum 506 of the received frame of reflected chirps transmitted by the three transmitters 504₁-504₃ when implementing DDMA with a single empty band. According to the fourth mapping 524 of FIG. 5D, the first indexed transmitter 504₁ of the radar circuit is mapped to the fourth band 514 of the Doppler domain spectrum 506 and corresponds to the first representation 516A of the object. In the example of FIG. 5D, the second indexed transmitter 504₂ of the radar circuit is mapped to the first band 508 of the Doppler domain spectrum 506 and corresponds to the second representation 516B of the object.

In the illustrated example of FIG. 5D, the third indexed transmitter 504₃ of the radar circuit is mapped to the second band 510 of the Doppler domain spectrum 506 and corresponds to the third representation 516_{C} of the object. Also, the third band 512 of the Doppler domain spectrum 506 is mapped to the empty band 518. If the three transmitters 504₁-504₃ and the empty band 518 are mapped to the Doppler domain spectrum 506 according to the fourth mapping 524, then a radar circuit can determine that the velocity of the target is between V_{MAX}/2 and V_{MAX}.

To perform DDMA disambiguation, a processor circuit (such as a radar backend processor device or a single-chip solution including an analog frontend) evaluates each of the potential mappings for a Doppler domain spectrum and determines which mapping results in the largest sum of energy in occupied bands according to the potential mappings. For example, for the first mapping 502 of FIG. 5A, a processor circuit sums the energy in the first band 508, the second band 510, and the third band 512 of the Doppler domain spectrum 506. Also, for the second mapping 520 of FIG. 5B, the processor circuit sums the energy in the second band 510, the third band 512, and the fourth band 514 of the Doppler domain spectrum 506.

For the third mapping 522 of FIG. 5C, the processor circuit sums the energy in the first band 508, the third band 512, and the fourth band 514 of the Doppler domain spectrum 506. Also, for the fourth mapping 524, the processor circuit sums the energy in the first band 508, the second band 510, and the fourth band 514 of the Doppler domain spectrum 506. To determine which mapping to apply to the Doppler domain spectrum 506, the processor circuit compares the sums determined for the first mapping 502, the second mapping 520, the third mapping 522, and the fourth mapping 524 and determines which mapping provides the largest sum. The processor circuit selects the mapping that provides the largest sum as the mapping for the Doppler domain spectrum 506.

In some examples, multiple contiguous empty bands can be included in a Doppler domain spectrum. For example, a Doppler domain spectrum for a radar circuit including four transmitters can include six bands (for example, four bands corresponding to the four transmitters and two contiguous empty bands). Adding multiple contiguous empty bands can improve DDMA disambiguation and object detection under at least one of weak signal or weak target conditions, resulting in better accuracy in object detection and/or classification. Also or alternatively, computational requirements to perform FFTs may require a Doppler domain spectrum to have a number of bins that corresponds to a power of two. As a result, the Doppler domain spectrum may include multiple contiguous empty bands.

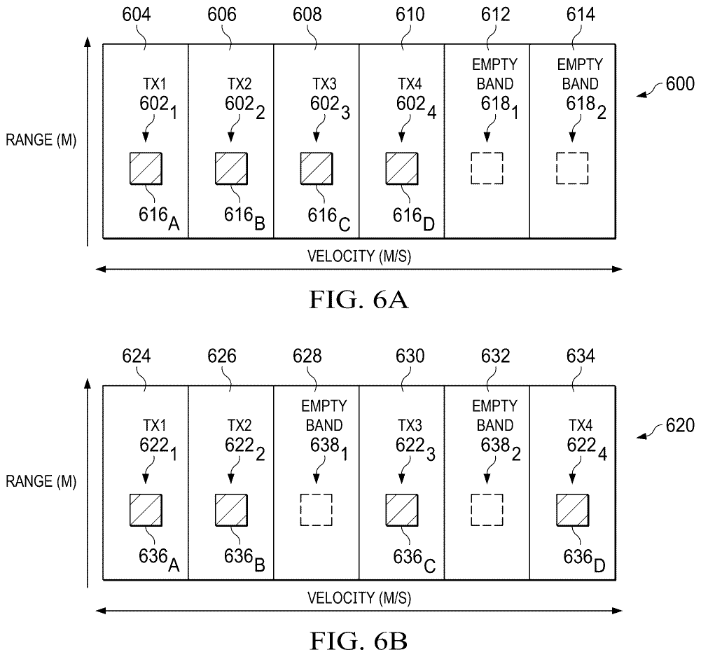

FIG. 6A is a diagram of an example Doppler domain spectrum 600 of a received frame of reflected chirps transmitted by four example transmitters 602₁-602₄ implementing DDMA with two contiguous empty bands and four contiguous occupied bands. In the example of FIG. 6A, the Doppler domain spectrum 600 includes a first example band 604, a second example band 606, a third example band 608, a fourth example band 610, a fifth example band 612, and a sixth example band 614. Also, some of the bands of the Doppler domain spectrum 600 include a representation of an object that reflected chirps transmitted into an environment.

In the illustrated example of FIG. 6A, the representation of the object in some of the bands corresponds to one of the transmitters that transmitted the chirps into the environment. In the Doppler domain spectrum 600 of FIG. 6A, an example first indexed transmitter 602₁ of the radar circuit is mapped to the first band 604 of the Doppler domain spectrum 600 and corresponds to a first example representation 616A of the object. In the example of FIG. 6A, an example second indexed transmitter 6022 of the radar circuit is mapped to the second band 606 of the Doppler domain spectrum 600 and corresponds to a second example representation 616B of the object.

In the illustrated example of FIG. 6A, an example third indexed transmitter 6023 of the radar circuit is mapped to the third band 608 of the Doppler domain spectrum 600 and corresponds to a third example representation 616_{C} of the object. In the example of FIG. 6A, an example fourth indexed transmitter 602₄ of the radar circuit is mapped to the fourth band 610 of the Doppler domain spectrum 600 and corresponds to a fourth example representation 616D of the object. Also, the fifth band 612 of the Doppler domain spectrum 600 is mapped to a first example empty band 6181 and the sixth band 614 of the Doppler domain spectrum 600 is mapped to a second example empty band 6182.

Examples of DDMA with one or more contiguous empty bands are described in commonly assigned U.S. Patent Application Publication No. 2023/0072441 (now U.S. Pat. No. 12,174,311), filed Sep. 3, 2021, entitled “Empty Band Doppler Division Multiple Access,” which is hereby incorporated herein by reference in its entirety. Also, example techniques to enable higher compression ratios in radar are described in commonly assigned U.S. Patent Application Publication No. 2024/0272275, filed Jul. 14, 2023, entitled “Technique to Enable Higher Compression Ratios in mmWave Radar,” which is hereby incorporated herein by reference in its entirety.

As illustrated in FIGS. 5A-5D and 6A, adding one or more contiguous empty bands to a Doppler domain spectrum of a received frame of reflected chirps can improve the reliability and/or accuracy of DDMA disambiguation. For example, adding one or more contiguous empty bands to a Doppler domain spectrum can improve the reliability and/or accuracy of DDMA disambiguation with a high enough signal-to-noise ratio (SNR) (for example, due to the absence of a representation of the target in the one or more contiguous empty bands). However, when there is a large amount of noise in a received frame of reflected chirps, a processor circuit may incorrectly perform DDMA disambiguation even with the presence of one or more contiguous empty bands.

To improve the reliability of DDMA disambiguation, two or more non-contiguous empty bands can be added to a Doppler domain spectrum. By controlling transmitters of a radar circuit to transmit at phases determined to result in two or more non-contiguous empty bands to occur in Doppler domain spectrum, the ability to perform DDMA disambiguation can be improved, for example, by sharpening the correlation function for object detection. FIG. 6B is a diagram of an example Doppler domain spectrum 620 of a received frame of reflected chirps transmitted by four example transmitters 622₁-622₄ implementing DDMA with at least two non-contiguous empty bands. In the example of FIG. 6B, the Doppler domain spectrum 620 includes a first example band 624, a second example band 626, a third example band 628, a fourth example band 630, a fifth example band 632, and a sixth example band 634. Also, some of the bands of the Doppler domain spectrum 620 include a representation of an object that reflected chirps transmitted into an environment by the transmitters 622₁-622₄ as described herein.

In the illustrated example of FIG. 6B, the representation of the object in some of the bands corresponds to one of the transmitters 622₁-622₄ that transmitted the chirps into the environment. In the Doppler domain spectrum 620 of FIG. 6B, an example first indexed transmitter 622₁ is mapped to the first band 624 of the Doppler domain spectrum 620 and corresponds to a first example representation 636_{A} of the object. In the example of FIG. 6B, an example second indexed transmitter 622₂ is mapped to the second band 626 of the Doppler domain spectrum 620 and corresponds to a second example representation 636_{B} of the object.

In the illustrated example of FIG. 6B, the third band 628 of the Doppler domain spectrum 620 is mapped to a first example empty band 638₁. In the example of FIG. 6B, an example third indexed transmitter 622₃ is mapped to the fourth band 630 of the Doppler domain spectrum 620 and corresponds to a third example representation 636_{C} of the object. Also, in the example of FIG. 6B, the fifth band 632 of the Doppler domain spectrum 620 is mapped to a second example empty band 638₂. In the example of FIG. 6B, an example fourth indexed transmitter 622₄ is mapped to the sixth band 634 of the Doppler domain spectrum 620 and corresponds to a fourth example representation 636p of the object.

As illustrated in FIG. 6B, the Doppler domain spectrum, 620 includes a plurality of bands where an object is represented in at least a portion of the plurality of the bands and at least three of the respective phase changes introduced by the transmitters 622₁-622₄ are non-consecutively distributed along the divisions of the phase spectrum. As such, responsive to the at least three of the respective phase changes introduced by the transmitters 622₁-622₄ being non-consecutively distributed along the divisions of the phase spectrum, the Doppler domain spectrum 620 includes at least two non-contiguous bands in which the object is not represented (also referred to as at least two non-contiguous empty bands). For example, (1) the object is not represented in the third band 628, (2) the fourth band 630 is contiguous with the third band 628 and the object is represented in the fourth band 630, and (3) the fifth band 632 is contiguous with the fourth band 630 and the object is not represented in the fifth band 632. Examples of DDMA with two or more non-contiguous empty bands are described in commonly assigned U.S. patent application Ser. No. 19/033,036, filed Jan. 21, 2025, entitled “Improved Disambiguation In Doppler Division Multiple-Access Radar,” which is hereby incorporated herein by reference in its entirety.

As illustrated in FIG. 6B, adding two or more non-contiguous empty bands to a Doppler domain spectrum of a received frame of reflected chirps can improve the reliability and/or accuracy of DDMA disambiguation in the presence of noise. For example, adding two or more non-contiguous empty bands to a Doppler domain spectrum can improve the reliability and/or accuracy of DDMA disambiguation when there is a large amount of noise in a received frame of reflected chirps. However, if two targets are at the same range, but the velocities of the two targets are offset such that the empty band(s) of one target overlap(s) with the signal bands of the other target, then a radar circuit may not be able to disambiguate the velocity of either target.

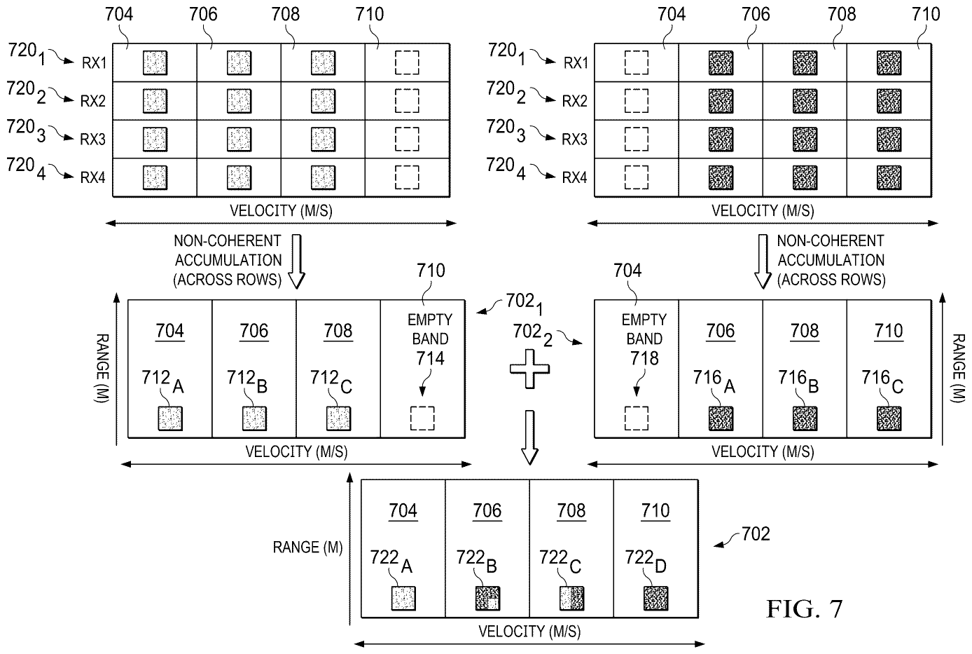

FIG. 7 is a graphical illustration of how the empty bands of a first example Doppler domain spectrum 702₁ and a second example Doppler domain spectrum 702₂ are eliminated when the objects corresponding to the first Doppler domain spectrum 702₁ and the second Doppler domain spectrum 702₂ are at the same range with offset velocities. In the example of FIG. 7, the first Doppler domain spectrum 702₁ corresponds to radar signals reflected from a first object responsive to a frame of chirps transmitted by a radar circuit. Also, the second Doppler domain spectrum 702₂ corresponds to radar signals reflected from a second object responsive to the frame of chirps transmitted by the radar circuit.

In the illustrated example of FIG. 7, each of the first Doppler domain spectrum 702₁ and the second Doppler domain spectrum 702₂ includes a first example band 704, a second example band 706, a third example band 708, and a fourth example band 710. Also, the first Doppler domain spectrum 702₁ includes a first example representation 712_{A} of the first object in the first band 704, a second example representation 712_{B} of the first object in the second band 706, and a third example representation 712_{C} of the first object in the third band 708. Also, the fourth band 710 corresponds to a first example empty band 714. In the example of FIG. 7, the second Doppler domain spectrum 702₂ includes a first example representation 716A of the second object in the second band 706, a second example representation 716B of the second object in the third band 708, and a third example representation 716_{C} of the second object in the fourth band 710. Also, the first band 704 corresponds to a second example empty band 718.

In the illustrated example of FIG. 7, the radar circuit non-coherently accumulates signal content in the first band 704, the second band 706, the third band 708, and the fourth band 710 across four example receivers 720₁-720₄ of the radar circuit to generate a unified Doppler domain spectrum. Under most circumstances, the radar circuit can distinguish between the two objects represented by the first Doppler domain spectrum 702₁ and the second Doppler domain spectrum 702₂. For example, provided that the first object and the second object are not at the same range or not offset in velocity to a point that the representations 712_{A}-712_{C} of the first object overlap with the representation 716A-716_{C} of the second object, the radar circuit can extract the first Doppler domain spectrum 702₁ and the second Doppler domain spectrum 702₂ from the unified Doppler domain spectrum.

Because, under most circumstances, the radar circuit can extract the first Doppler domain spectrum 702₁ and the second Doppler domain spectrum 702₂ as individual Doppler domain spectrums corresponding to individual objects, the radar circuit can, under most circumstances, disambiguate the velocities of the first object and the second object. For example, under most circumstances, the radar circuit can disambiguate the velocities of the first object and the second object by matching each of the first Doppler domain spectrum 702₁ and the second Doppler domain spectrum 702₂ to one of the mappings of FIGS. 5A-5D. However, in the example of FIG. 7, the first object and the second object are at the same range and have velocities that are offset by V_{MAX}/2. For example, such circumstances may arise in crowded urban environments. Also or alternatively, such circumstances may arise in tunnels or when objects are near highway guardrails.

Under such circumstances, the first empty band 714 overlaps with the fourth band 710 which includes the third representation 716_{C} of the second object and the second empty band 718 overlaps with the first band 704 which includes the first representation 712_{A} of the first object. Thus, when the radar circuit non-coherently accumulates received radar signals across the four receivers 720₁-720₄, the radar circuit generates an example unified Doppler domain spectrum 702 that includes no empty bands. For example, the unified Doppler domain spectrum 702 includes a first example signal peak 722_{A} in the first band 704, a second example signal peak 722_{B} in the second band 706, a third example signal peak 722_{C} in the third band 708, and a fourth example signal peak 722_{D} in the fourth band 710.

As such, the first empty band 714 and the second empty band 718 are corrupted. In the absence of a reliable empty band, the radar circuit cannot reliably perform disambiguation as described above. Thus, angle and velocity estimates of targets will be corrupted and object detection and tracking capabilities will be diminished. Even if an empty band were present, the unified Doppler domain spectrum 702 includes signal content corresponding to both the first object and the second object, further corrupting the data. For example, the second signal peak 722_{B} and the third signal peak 722_{C} include signal content corresponding to both the first object and the second object.

Examples described herein perform transmitter disambiguation even when the Doppler domain spectrum does not include an empty band (also referred to as empty band corruption or band collision). For example, described systems, methods, apparatus, and articles of manufacture include a receiver antenna-based angle estimation technique to resolve band collisions (also referred to as empty band corruption). Described examples include detecting a multi-object band collision, estimating coarse angles of the objects with respect to a radar circuit based on radar signals received at the receiver antennas of the radar circuit, and performing transmitter disambiguation based on the coarsely estimated angles. As such, examples described herein bridge an important gap in DDMA modulation schemes. Moreover, the techniques of this description can be implemented in some examples without at least one of additional hardware for existing systems or any increased latency and without using additional computational resources.

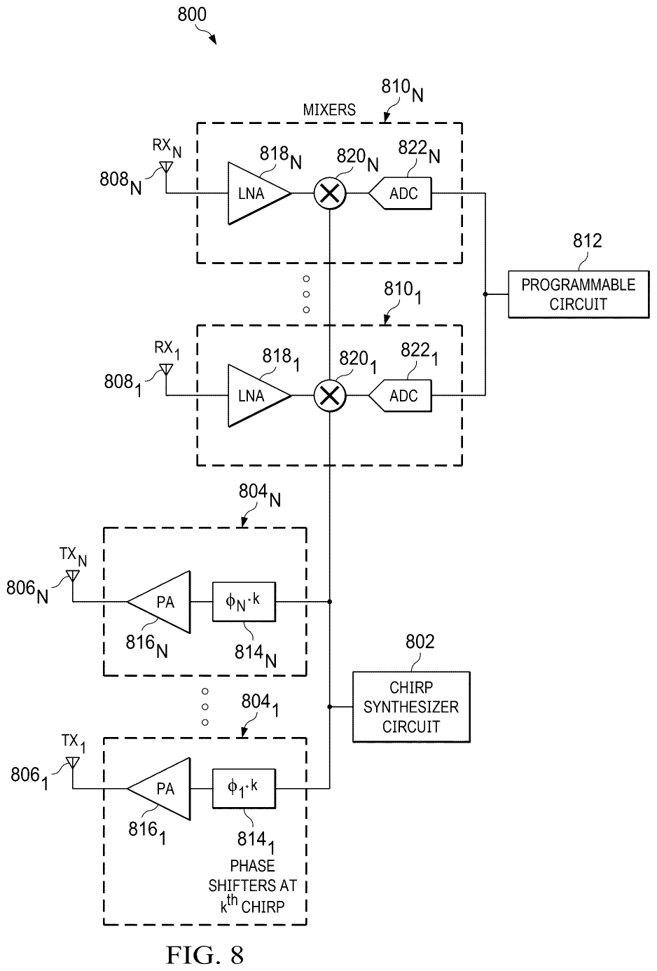

FIG. 8 is a block diagram of an example radar transceiver integrated circuit (IC) 800 that can implement any of the radar circuits 102_{A}-102_{H} of FIG. 1. In the example of FIG. 8, the radar transceiver IC 800 is a Doppler division multiple-access radar device. For example, the radar transceiver IC 800 includes an example chirp synthesizer circuit 802, example transmitters 804₁-804_{N}, example transmit antennas 806₁-806_{N}, example receive antennas 808₁-808_{N}, example receivers 810₁-810_{N}, and an example programmable circuit 812. Also, in the example of FIG. 8, the transmitters 804₁-804_{N} include example phase shifters 814₁-814_{N} and example power amplifiers (PAS) 816₁-816_{N}, respectively.

In the illustrated example of FIG. 8, the receivers 810₁-810_{N} include example low noise amplifiers (LNAs) 818₁-818_{N}, example mixers 820₁-820_{N}, and example analog-to-digital converters (ADCs) 822₁-822_{N}, respectively. In the example of FIG. 8, the radar transceiver IC 800 includes four of each of the transmitters 804₁-804_{N}, the transmit antennas 806₁-806_{N}, the receive antennas 808₁-808_{N}, and the receivers 810₁-810_{N} (for example, N equals four). In some examples, the radar transceiver IC 800 includes a different numbers of any of the transmitters 804₁-804_{N}, the transmit antennas 806₁-806_{N}, the receive antennas 808₁-808_{N}, or the receivers 810₁-810_{N}.

In some examples, the radar transceiver IC 800 and the programmable circuit 812 are implemented separately and may be configurable to be coupled together. For example, the radar transceiver IC 800 and the programmable circuit 812 may be implemented as separate chips or in separate packages, e.g., as analog frontend circuitry and a digital backend device such as a processor-only device. In such examples, the transmit antennas 806₁-806_{N} or the receive antennas 808₁-808_{N} may be implemented externally to the radar transceiver IC 800 or internally to the radar transceiver IC 800, for example, as antennas-on-package (AOP). Also or alternatively, the radar transceiver IC 800 is implemented with the programmable circuit 812. For example, the radar transceiver IC 800 and the programmable circuit 812 may be implemented as a single chip or within a single package such as a SoC (such as a single IC).

In such examples, the transmit antennas 806₁-806_{N} or the receive antennas 808₁-808_{N} may be implemented externally to the radar transceiver IC 800 or internally to the radar transceiver IC 800, for example, as AOPs. In examples where the radar transceiver IC 800, the programmable circuit 812, the transmit antennas 806₁-806_{N}, and receive antennas 808₁-808_{N} are implemented in a single chip with AOPs, the single chip may be referred to as a launch-on-package (LOP). Also, in examples where the radar transceiver IC 800 is implemented with the programmable circuit 812 on a SoC, the radar transceiver IC 800 may correspond to a sub-circuit of the IC that forms the SoC.

In the illustrated example of FIG. 8, the chirp synthesizer circuit 802 is implemented by at least one of analog or digital circuitry. In the example of FIG. 8, the chirp synthesizer circuit 802 is coupled to the transmitters 804₁-804_{N}. For example, the chirp synthesizer circuit 802 is coupled to the phase shifters 814₁-814_{N} of the transmitters 804₁-804_{N}. Also, in the example of FIG. 8, the chirp synthesizer circuit 802 is coupled to the receivers 810₁-810_{N}. For example, the chirp synthesizer circuit 802 is coupled to the mixers 820₁-820_{N} of the receivers 810₁-810_{N}. In some examples, the chirp synthesizer circuit 802 is coupled to the programmable circuit 812.

In the illustrated example of FIG. 8, each of the phase shifters 814₁-814_{N} is implemented by at least one of analog or digital circuitry. In the example of FIG. 8, each of the phase shifters 814₁-814_{N} is coupled to the chirp synthesizer circuit 802. Also, in the example of FIG. 8, the phase shifters 814₁-814_{N} are coupled to the PAs 816₁-816_{N} (for example, respective phase shifters are coupled to respective PAs). In the example of FIG. 8, each of the PAs 816₁-816_{N} is implemented by at least one of analog or digital circuitry. Also, in the example of FIG. 8, the PAs 816₁-816_{N} are coupled to the phase shifters 814₁-814_{N} and the transmit antennas 806₁-806_{N}.

In the illustrated example of FIG. 8, the chirp synthesizer circuit 802 includes functionality to receive chirp parameter values (for example, from the programmable circuit 812) for a sequence of chirps in a radar frame. In some examples, the chirp parameters are defined by the radar system architecture and may include, for example, a transmitter enable parameter for indicating which of the transmitters 804₁-804_{N} to enable, a chirp frequency start value, a chirp frequency slope, an ADC sampling time, a ramp end time, and a transmitter start time, among others. In the example of FIG. 8, the chirp synthesizer circuit 802 also includes functionality to generate signals (for example, a chirp, a frame of chirps, etc.) for transmission based on the chirp parameter values (for example, received from the programmable circuit 812). In some examples, the chirp synthesizer circuit 802 includes a phase locked loop (PLL) oscillator with a voltage-controlled oscillator (VCO). In additional or alternative examples, the chirp synthesizer circuit 802 includes a local oscillator (LO).

In the illustrated example of FIG. 8, each of the phase shifters 814₁-814_{N} receives the output signal provided by the chirp synthesizer circuit 802 (for example, a chirp, a frame of chirps, etc.) and modulates the output signal provided by the chirp synthesizer circuit 802 based on respective phase changes to generate a frame of chirps having a linear phase change across chirps. For example, for an example first indexed transmitter 804₁, an example first indexed phase shifter 814₁ applies a first phase change @1 between consecutive chirps of a frame. As such, the first indexed phase shifter 814₁ generates a frame of chirps where the phase changes between consecutive chirps of the frame are equal (for example, for TX₁ ΔΦ_{C1-C2}=ΔΦ_{C2-C3}=ΔΦ_{C3-C4} . . . =ΔΦ_{C(N-1)-CN)}.

Also, for example, for an example Nth indexed transmitter 804_{N}, an example Nth indexed phase shifter 814_{N} applies an Nth phase change Φ_{N} between consecutive chirps of a frame. As such, the Nth indexed phase shifter 814_{N} generates a frame of chirps where the phase changes between consecutive chirps of the frame are equal (for example, for TX_{N} ΔΦ_{C1-C2}=ΔΦ_{C2-C3}=ΔΦ_{C3-C4} . . . =ΔΦ_{C(N-1)-CN)}. In the example of FIG. 8, the transmitters 804₁-804_{N} transmit frames of chirps simultaneously where each of the transmitters 804₁-804_{N} imparts a phase change (Φ) across the chirps of the frame as described above.

In the illustrated example of FIG. 8, each of the LNAs 818₁-818_{N} is implemented by at least one of analog or digital circuitry. In the example of FIG. 8, the LNAs 818₁-818_{N} are coupled to the mixers 820₁-820_{N} and the receive antennas 808₁-808_{N}. Also, each of the mixers 820₁-820_{N} is implemented by at least one of analog or digital circuitry. In the example of FIG. 8, the mixers 820₁-820_{N} are coupled to the chirp synthesizer circuit 802, the LNAs 818₁-818_{N}, and the ADCs 822₁-822_{N}.

In the illustrated example of FIG. 8, each of the ADCs 822₁-822_{N} is implemented by at least one of analog or digital circuitry. In the example of FIG. 8, the ADCs 822₁-822_{N} are coupled to the mixers 820₁-820_{N} and the programmable circuit 812. Also, the programmable circuit 812 is implemented by at least one of analog or digital circuitry. For example, the programmable circuit 812 may be implemented by a DSP, a microcontroller, an FFT engine, a combined DSP and microcontroller processor, an FPGA, or an application specific integrated circuit (ASIC). In the example of FIG. 8, the programmable circuit 812 is coupled to the ADCs 822₁-822_{N}. In some examples, the programmable circuit 812 is coupled to the chirp synthesizer circuit 802.

In the illustrated example of FIG. 8, each of the receive antennas 808₁-808_{N} receives signals reflected from an environment in a field of view of the radar transceiver IC 800. For example, each of the receive antennas 808₁-808_{N} receives frames of reflected chirps from the environment. Also, each of the LNAs 818₁-818_{N} amplifies the received frames of reflected chirps and forwards the amplified received frames to the mixers 820₁-820_{N}. In the example of FIG. 8, each of the mixers 820₁-820_{N} mixes the amplified received frames with the frame of chirps provided by the chirp synthesizer circuit 802 to produce IF received frames of reflected chirps. Also, each of the ADCs 822₁-822_{N} converts the IF received frames of reflected chirps from analog signals (for example, radar signals) to digital signals (for example, radar data).

In some examples, the radar transceiver IC 800 includes digital front end (DFE) circuitry between the ADCs 822₁-822_{N} and the programmable circuit 812. For example, the DFE circuitry receives IF signals from the receivers 810₁-810_{N} and performs decimation filtering or other processing operations on the digital IF signals, for example, to reduce the data transfer rate of the digital IF signals. Also or alternatively, the DFE circuitry performs other operations on the digital IF signals such as direct current (DC) offset removal or compensation (also referred to as digital compensation) of non-idealities in the receivers 810₁-810_{N} such as inter-receiver gain imbalance non-ideality, inter-receiver phase imbalance non-ideality, and the like.

In some examples, the radar transceiver IC 800 includes memory coupled to the ADCs 822₁-822_{N} and the programmable circuit 812. For example, the memory stores radar data (for example, digital signals) provided by the ADCs 822₁-822_{N} for further processing by the programmable circuit 812. As such, the programmable circuit 812 can access the radar data from the memory to perform processing (for example, transmitter disambiguation) based on the radar data. The example memory may be implemented by random-access memory (RAM) (such as static RAM (SRAM)), Synchronous Dynamic Random Access Memory (SDRAM), Dynamic Random Access Memory (DRAM), RAMBUS® Dynamic Random Access Memory (RDRAM®), or any other type of RAM device.

In the illustrated example of FIG. 8, the programmable circuit 812 is configured to perform at least a portion of signal processing on the digital IF signals resulting from a received radar frame. In some examples, the programmable circuit 812 is configured to transmit the results of signal processing. For example, the programmable circuit 812 transmits the results of signal processing to a processing unit (for example, the programmable circuit 104). In some examples, the programmable circuit 812 interfaces with another device via a high-speed interface or an SPI.

In the illustrated example of FIG. 8, the programmable circuit 812 performs a range FFT on each received frame of reflected chirps. Also or alternatively, the programmable circuit 812 performs a Doppler FFT on results of range FFTs. In examples described herein, the range-Doppler heatmap or range-Doppler representation generated as the output of the Doppler FFT is referred to as a Doppler domain spectrum. In some examples, the programmable circuit 812 receives control information (for example, timing of chirps, power level, triggering of monitoring functions, etc.) via an SPI. For example, based on the control information, the programmable circuit 812 provides data parameters or provides control signals to the chirp synthesizer circuit 802.

As described above, if two targets are at the same range but the velocities of the two targets are offset such that the empty band of one target overlaps with a signal band of the other target, then the empty band will be corrupted. However, if the two targets are sufficiently separated in the angle domain, then reliable disambiguation is still possible. For example, while a complete angle fast Fourier transform (FFT) (for example, using the entire virtual array including the transmit antennas 806₁-806_{N} and the receive antennas 808₁-808_{N}) is not possible (for example, because the transmit antennas 806₁-806_{N} have not been disambiguated), the programmable circuit 812 can coarsely estimate the angles of the two targets based on only the receive antennas 808₁-808_{N}.

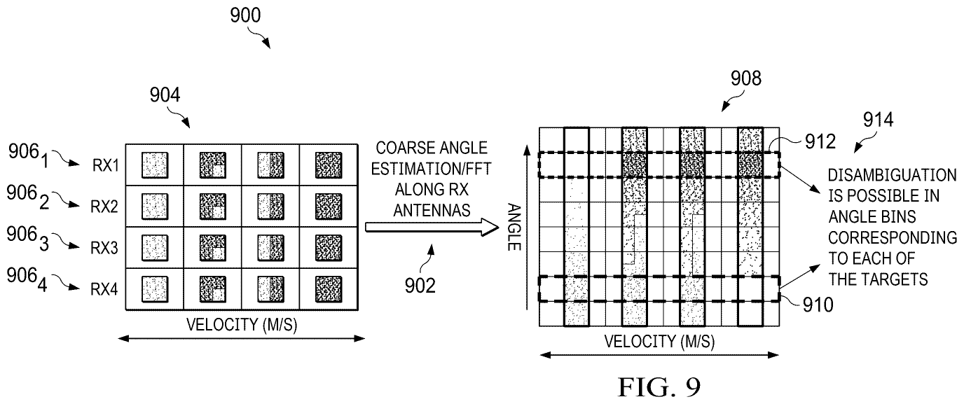

Advantageously, the programmable circuit 812 implements a receiver antenna-based angle estimation technique to resolve band collisions (also referred to as empty band corruption). For example, FIG. 9 is a diagram of an example processing flow 900 to disambiguate a first object and a second object detected in radar data. In the example of FIG. 9, a first example process 902 includes the programmable circuit 812 performing coarse angle estimation based on an example non-accumulated Doppler domain spectrum 904. For example, coarse angle estimation includes determining an angle of the first object with respect to the radar transceiver IC 800 and an angle of the second object with respect to the radar transceiver IC 800.

In the illustrated example of FIG. 9, the non-accumulated Doppler domain spectrum 904 is a matrix including rows of Doppler domain data corresponding to four example receivers 906₁-906₄. For example, each row of the non-accumulated Doppler domain spectrum 904 corresponds to one of the receivers 906₁-906₄ and includes Doppler domain data provided by that receiver. In some examples, the programmable circuit 812 performs coarse angle estimation based on an FFT performed across receivers. For example, the programmable circuit 812 performs coarse angle estimated based on an FFT of the non-accumulated Doppler domain spectrum 904 performed across the receivers 906₁-906₄. The location of peaks in the FFT corresponds to the angle-of-arrival (AOA) of a radar signal reflected from an object in the field of view (FOV) of a radar. For example, the AOA can correspond to the azimuth angle (also referred to as horizontal angle) or the elevation angle (also referred to as vertical angle) of a radar signal. Also or alternatively, the programmable circuit 812 performs coarse angle estimation based on processing the non-accumulated Doppler domain spectrum 904 according to a high angle resolution algorithm such as a Multiple Signal Classification (MUSIC) algorithm.

In the illustrated example of FIG. 9, the first process 902 also includes the programmable circuit 812 performing an FFT on the non-accumulated Doppler domain spectrum 904 across the receivers 906₁-906₄. For example, the programmable circuit 812 performs the FFT over eight angle bins. In some examples, the programmable circuit 812 performs the FFT over 32 angle bins. In general, the programmable circuit 812 can perform a zero-padded FFT. For example, a zero-padded FFT is an FFT where the number of angle bins in the output is larger than the number of receivers at the input. Performing an FFT on the non-accumulated Doppler domain spectrum 904 across the receivers 906₁-906₄ converts the non-accumulated Doppler domain spectrum 904 to the angle domain. By performing an FFT on the non-accumulated Doppler domain spectrum 904 across the receivers 906₁-906₄, the programmable circuit 812 generates an example angle Fourier transform (FT) 908 of the non-accumulated Doppler domain spectrum 904.

In the illustrated example of FIG. 9, each of the receivers 906₁-906₄ receives the same radar signal, but there is a phase offset between respective ones of the receivers 906₁-906₄. As such, when the programmable circuit 812 performs an FFT across the receivers 906₁-906₄, the programmable circuit 812 can distinguish the AOA of the radar signal with respect to each of the receivers 906₁-906₄. For example, the angle FT 908 is a matrix including rows of Doppler domain data corresponding to angle bins. In other words, each row of the angle FT 908 corresponds to one angle bin and includes Doppler domain data for that angle bin.

As such, disambiguation of the first object and the second object is possible in the angle domain. For example, by applying the coarsely estimated angles of the first object and the second object to the angle FT 908, the programmable circuit 812 can identify a first example angle bin 910 of the angle FT 908 that corresponds to the first object and a second example angle bin 912 of the angle FT 908 that corresponds to the second object. In the example of FIG. 9, a second example process 914 includes the programmable circuit 812 matching the Doppler domain data in at least the first angle bin 910 and at least the second angle bin 912 to one of the mappings of FIGS. 5A-5D.

In some examples, if there are fewer receivers than the number of angle bins over which the programmable circuit 812 performs the FFT to generate the angle FT 908, the programmable circuit 812 evaluates a group of angle bins. For example, because there are four of the receivers 906₁-906₄ and the programmable circuit 812 performs the FFT over eight angle bins to generate the angle FT 908, the signal content of the non-accumulated Doppler domain spectrum 904 is spread across more bins in the angle dimension than the number of the receivers 906₁-906₄. As such, there is a risk that some of the angle bins of the angle FT 908 are corrupted (for example, due to noise, another object that is very close in the angle dimension, etc.).

Advantageously, the programmable circuit 812 considers the signal content in a group of angle bins around each of the first angle bin 910 and the second angle bin 912. For example, the programmable circuit 812 evaluates the signal content in a first group of angle bins around the first angle bin 910 and evaluates the signal content in a second group of angle bins around the second angle bin 912. As such, the programmable circuit 812 can more reliably determine the true mapping corresponds to each of the first object and the second object.

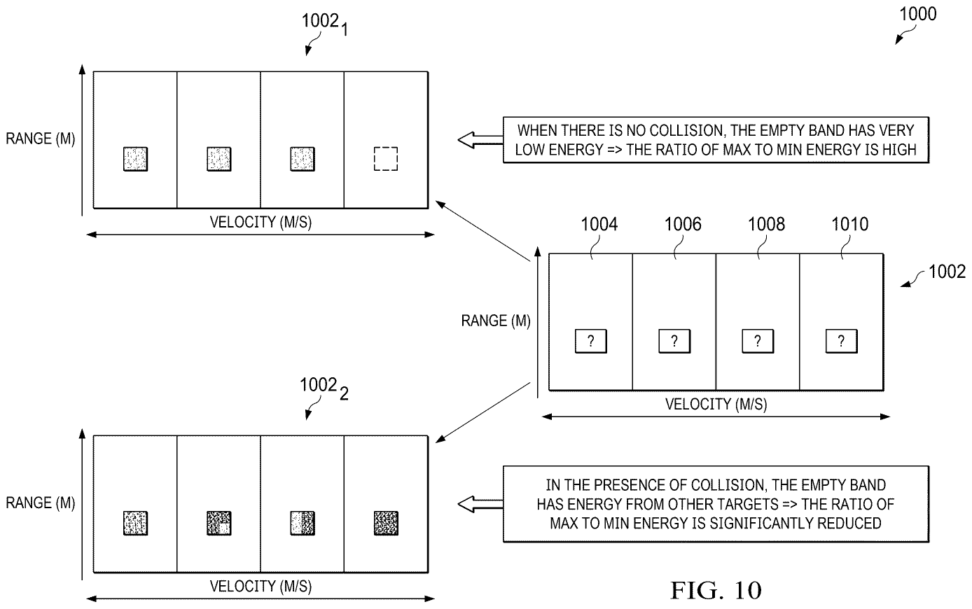

As described above, the programmable circuit 812 can disambiguate between multiple objects detected in radar data even in the event of band collision. Performing disambiguation in the event of band collision consumes additional computational resources compared to disambiguation with at least one empty band. Advantageously, the programmable circuit 812 determines whether to expend the additional computational resources to disambiguate multiple objects without an empty band. For example, FIG. 10 is a diagram of an example processing flow 1000 to determine whether to perform the processing flow 900 of FIG. 9.

In the illustrated example of FIG. 10, the processing flow 1000 includes determining whether an example ambiguous Doppler domain spectrum 1002 of a received frame of reflected chirps corresponds to a first example Doppler domain spectrum 1002₁ or a second example Doppler domain spectrum 1002₂. For example, the first Doppler domain spectrum 1002₁ includes a single empty band and the second Doppler domain spectrum 1002₂ includes no empty bands. In the example of FIG. 10, the ambiguous Doppler domain spectrum 1002 includes a first example band 1004, a second example band 1006, a third example band 1008, and a fourth example band 1010.

To determine whether the ambiguous Doppler domain spectrum 1002 corresponds to the first Doppler domain spectrum 1002₁ or the second Doppler domain spectrum 1002₂, the programmable circuit 812 determines a ratio between a maximum energy and a minimum energy in the first band 1004, the second band 1006, the third band 1008, and the fourth band 1010. In the example of FIG. 10, the programmable circuit 812 also determines whether the ratio satisfies a threshold indicative of a band collision in the ambiguous Doppler domain spectrum 1002. For example, the programmable circuit 812 determines whether the ratio is less than the threshold.

In the illustrated example of FIG. 10, if the ambiguous Doppler domain spectrum 1002 corresponds to the first Doppler domain spectrum 1002₁, then the ambiguous Doppler domain spectrum 1002 will include an empty band with very low energy. As such, the ratio between the maximum energy and the minimum energy will be high and will likely exceed the threshold. As a result, the programmable circuit 812 can determine that band collision has not occurred. For example, responsive to the programmable circuit 812 determining that the ratio does not satisfy the threshold, the programmable circuit 812 determines that the ambiguous Doppler domain spectrum 1002 corresponds to the first Doppler domain spectrum 1002₁ and that disambiguation with at least one empty band can be performed.

Alternatively, if the ambiguous Doppler domain spectrum 1002 corresponds to the second Doppler domain spectrum 1002₂, then any empty bands that would be present in the ambiguous Doppler domain spectrum 1002 will be corrupted and include energy corresponding to one or more targets. As such, the ratio between the maximum energy and the minimum energy will be significantly reduced and will not likely exceed the threshold. As a result, the programmable circuit 812 can determine that band collision has occurred. For example, responsive to the programmable circuit 812 determining that the ratio satisfies the threshold, the programmable circuit 812 determines that the ambiguous Doppler domain spectrum 1002 corresponds to the second Doppler domain spectrum 1002₂ and that the processing flow 900 of FIG. 9 is to be performed.

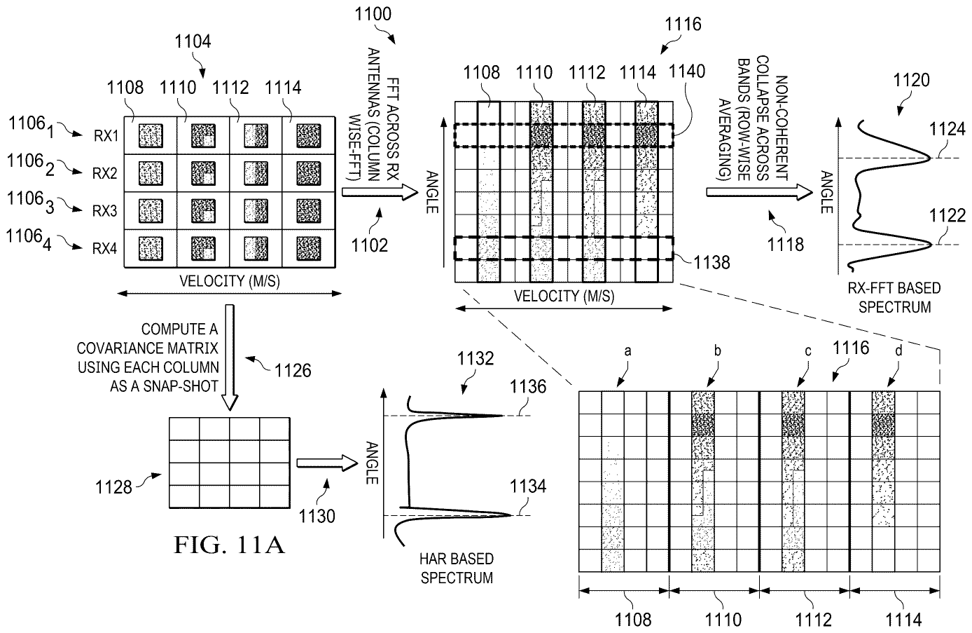

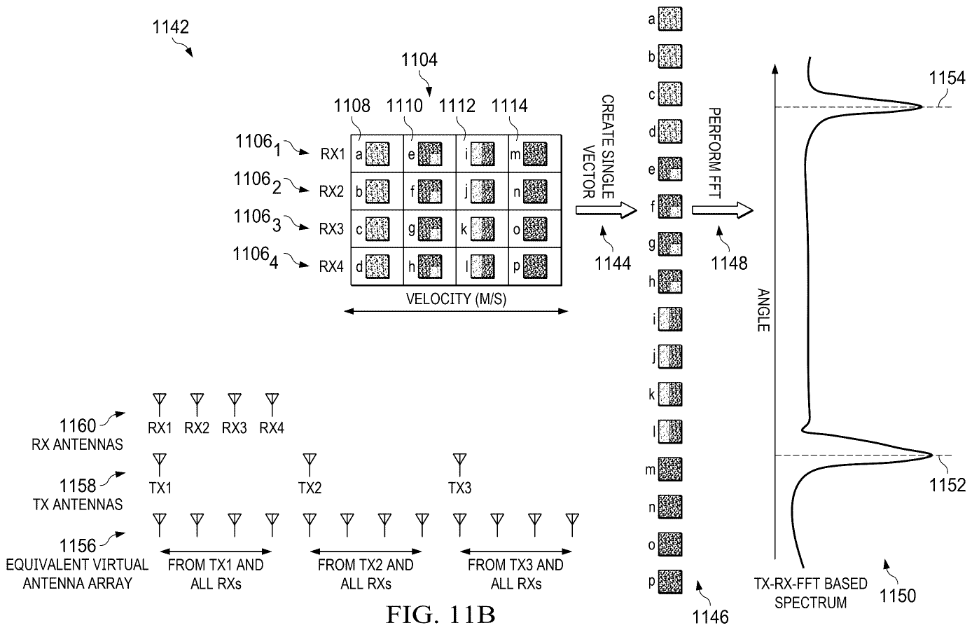

FIG. 11A is a diagram of an example processing flow 1100 to perform coarse angle estimation at the first process 902 of FIG. 9. As described above, the programmable circuit 812 can perform coarse angle estimation based on an FFT of an example non-accumulated Doppler domain spectrum performed across radar receivers or based on a high angle resolution (HAR) algorithm. In the example of FIG. 11A, a first example operation 1102 includes the programmable circuit 812 performing an FFT of an example non-accumulated Doppler domain spectrum 1104 across four example receivers 1106₁-1106₄.

In the illustrated example of FIG. 11A, the non-accumulated Doppler domain spectrum 1104 is a matrix including rows of Doppler domain data corresponding to the four receivers 1106₁-1106₄. For example, each row of the non-accumulated Doppler domain spectrum 1104 corresponds to one of the receivers 1106₁-1106₄ and includes Doppler domain data provided by that receiver. Also, each column of the non-accumulated Doppler domain spectrum 1104 represents a band of the Doppler domain. For example, the non-accumulated Doppler domain spectrum 1104 includes a first example band 1108, a second example band 1110, a third example band 1112, and a fourth example band 1114. In the example of FIG. 11A, the non-accumulated Doppler domain spectrum 1104 corresponds to a single range bin. In additional or alternative examples, non-accumulated Doppler domain data may include any number of range bins.

In the illustrated example of FIG. 11A, by performing an FFT on the non-accumulated Doppler domain spectrum 1104 across the receivers 1106₁-1106₄, the programmable circuit 812 generates an example angle Fourier transform (FT) 1116 of the non-accumulated Doppler domain spectrum 1104. In the example of FIG. 11A, a second example process 1118 includes the programmable circuit 812 non-coherently collapsing or accumulating signal content of the angle FT 1116 across bands of the Doppler domain. For example, each of the four bands of the angle FT 1116 includes multiple columns where each column corresponds to specific Doppler data. In the example of FIG. 11A, each of the first band 1108, the second band 110, the third band 1112, and the fourth band 1114 includes four columns of Doppler data. In general, the number of columns per band can be larger. For example, each band can include 64 columns. In the example of FIG. 11A, the Doppler data of interest is present in the second column (from left to right) of each of the first band 1108, the second band 1110, the third band 1112, and the fourth band 1114 which are identified as a, b, c, and d, respectively. Non-coherently collapsing or accumulating the signal content of the angle FT 1116 across bands of the Doppler domain refers to the programmable circuit 812 accumulating across the corresponding columns of Doppler data for each band. For example, the programmable circuit 812 accumulates the signal content in column a, column b, column c, and column d. In some examples, non-coherent collapse or accumulation is referred to as the programmable circuit 812 performing row-wise averaging of signal content of the angle FT 1116 across the first band 1108, the second band 1110, the third band 1112, and the fourth band 1114.

In the illustrated example of FIG. 11A, by non-coherently collapsing or accumulating signal content of the angle FT 1116 across the bands of the Doppler domain, the programmable circuit 812 generates an example RX-FFT-based angle spectrum 1120. For example, the RX-FFT-based angle spectrum 1120 includes signal magnitude across angle of reception. In the example of FIG. 11A, the location of peaks in the RX-FFT-based angle spectrum 1120 corresponds to the AOA of a radar signal reflected from an object in the FOV of a radar. Based on the RX-FFT-based angle spectrum 1120, the programmable circuit 812 determines a first example peak 1122 and a second example peak 1124. For example, the first peak 1122 corresponds to a first candidate angle of a first object with respect to a radar and the second peak 1124 corresponds to a first candidate angle of a second object with respect to the radar. In examples described herein, the programmable circuit 812 can determine the first peak 1122 and the second peak 1124 using several techniques or a combination thereof. Example peak detection techniques include Constant False Alarm Rate (CFAR) detection, Local Maxima detection, among others.

In the illustrated example of FIG. 11A, the programmable circuit 812 can perform coarse angle estimation based on a HAR algorithm as described above. In the example of FIG. 11A, a third example process 1126 includes the programmable circuit 812 processing the non-accumulated Doppler domain spectrum 1104 according to a HAR algorithm. For example, the programmable circuit 812 processes the non-accumulated Doppler domain spectrum 1104 according to a MUSIC algorithm. By processing the non-accumulated Doppler domain spectrum 1104 according to a MUSIC algorithm, the programmable circuit 812 generates or computes an example covariance matrix 1128. For example, the programmable circuit 812 utilizes each column or band of the non-accumulated Doppler domain spectrum 1104 as a snapshot to compute the covariance matrix 1128. Denoting each column or band as x, the covariance matrix is computed as Σ_{across bands}xx^{T}.

As described above, a MUSIC algorithm is an example of a HAR algorithm. Example MUSIC algorithms include “Multiple Emitter Location and Signal Parameter Estimation” as described by R. Schmidt in IEEE Transactions on Antennas and Propagation, Vol. 34, No. 3, pages 276-280, March 1986. Additional or alternative MUSIC algorithms include the Root-MUSIC algorithm as described in “Performance Analysis of Root-Music,” by B. D. Rao and K. V. S. Hari in IEEE Transactions on Acoustics, Speech, and Signal Processing, Vol. 37, No. 12, pages 1939-1949, December 1989. Additional or alternative HAR algorithms include the Minimum Variance Distortionless Response Beamformer (also referred to as the Capon Beamformer) as described in “High-Resolution Frequency-Wavenumber Spectrum Analysis” by J. Capon in Proceedings of the IEEE, Vol. 57, No. 8, pages 1408-1418, August 1969. In general, the programmable circuit 812 can utilize any such algorithm that only requires receiver antenna snapshots (for example, bands of the non-accumulated Doppler domain spectrum 1104) to operate and does not require disambiguation results to operate.

In the illustrated example of FIG. 11A, a fourth example process 1130 includes the programmable circuit 812 performing eigen decomposition on the covariance matrix 1128 to generate an example HAR-based angle spectrum 1132. For example, the HAR-based angle spectrum 1132 includes signal magnitude across angle of reception. In the example of FIG. 11A, the location of peaks in the HAR-based angle spectrum 1132 corresponds to the AOA of a radar signal reflected from an object in the FOV of a radar. Based on the HAR-based angle spectrum 1132, the programmable circuit 812 determines a third example peak 1134 and a fourth example peak 1136. For example, the third peak 1134 corresponds to a second candidate angle of the first object with respect to the radar and the fourth peak 1136 corresponds to a second candidate angle of the second object with respect to the radar.

In some examples, the determination of how to perform coarse angle estimation is hardcoded. For example, HAR algorithms can be computationally intensive. As such, if the programmable circuit 812 is at least one of computationally constrained or cannot perform HAR algorithm-based coarse angle estimation within a required time, the programmable circuit 812 is hardcoded to perform FFT-based coarse angle estimation. Alternatively, if the programmable circuit 812 is not computationally constrained or can perform HAR algorithm-based coarse angle estimation within a required time, the programmable circuit 812 is hardcoded to perform HAR algorithm-based coarse angle estimation.

In some examples, the determination of how to perform coarse angle estimation is made on-the-fly, in substantially real time. For example, provided that the programmable circuit 812 has sufficient computational resources to perform HAR algorithm-based coarse angle estimation, the programmable circuit 812 can determine how to perform coarse angle estimation on-the-fly. In such examples, if the separation between objects is expected to be larger than the native resolution of the receivers 1106₁-1106₄, the programmable circuit 812 determines to perform FFT-based coarse angle estimation.

Alternatively, if the separation between objects is expected to be smaller than the native resolution of the receivers 1106₁-1106₄ and the programmable circuit 812 can perform HAR algorithm-based coarse angle estimation within a required time, the programmable circuit 812 determines to perform HAR algorithm-based coarse angle estimation. In general, FFT-based coarse angle estimation consumes less computational resources than HAR algorithm-based coarse angle estimation but has lower resolution than HAR algorithm-based coarse angle estimation. For example, the third peak 1134 and the fourth peak 1136 are sharper than the first peak 1122 and the second peak 1124, respectively.

Advantageously, when two objects are very close together in the angle dimension the relatively finer-grained analysis provided by HAR algorithm-based coarse angle estimation allows the programmable circuit 812 to distinguish between the two objects. Under such circumstances, a HAR algorithm can improve the angular separation at which band collisions can be resolved compared to FFT-based coarse angle estimation, assuming the SNR of the Doppler domain data is high enough (for example, exceeds an empirically derived threshold). For example, to provide reliable results, HAR algorithm-based coarse angle estimation may require a relatively higher SNR than FFT-based coarse angle estimation.

In some examples, the programmable circuit 812 can perform tiered coarse angle estimation. For example, if computational resources are scarce, the programmable circuit 812 performs FFT-based coarse angle estimation and validates whether the estimated angles suffice for multi-object disambiguation. To validate whether the estimated angles suffice for multi-object disambiguation, the programmable circuit 812 applies the coarsely estimated angles of the first object and the second object to the angle FT 1116. By doing so, the programmable circuit 812 can identify a first example angle bin 1138 of the angle FT 1116 that corresponds to the first object and a second example angle bin 1140 of the angle FT 1116 that corresponds to the second object.

For the first angle bin 1138 and the second angle bin 1140, the programmable circuit 812 checks for band collisions (for example, checks if there are multiple targets represented in one or more of the first angle bin 1138 or the second angle bin 1140). For example, for each of the first angle bin 1138 and the second angle bin 1140, the programmable circuit 812 determines a ratio between a maximum energy and a minimum energy in bands of the Doppler representation. In the example of FIG. 11A, for each of the first angle bin 1138 and the second angle bin 1140, the programmable circuit 812 determines a ratio between a maximum energy and a minimum energy in column a, column b, column c, and column d. If the ratio is below an empirically determined threshold, then the programmable circuit 812 determines that there is a band collision. If a band collision is present, the programmable circuit 812 performs HAR algorithm-based coarse angle estimation. If not, the programmable circuit 812 utilizes the FFT-based coarsely estimated angles to perform disambiguation as described herein.

FIG. 11B is a diagram of another example processing flow 1142 to perform coarse angle estimation at the first process 902 of FIG. 9. In the example of FIG. 11B, a first example process 1144 includes reformatting the non-accumulated Doppler domain spectrum 1104 into an example vector 1146. As described above, the non-accumulated Doppler domain spectrum 1104 is a matrix including rows of Doppler domain data corresponding to the four receivers 1106₁-1106₄ where each column represents a band of the Doppler domain. Also, as described above, the non-accumulated Doppler domain spectrum 1104 includes the first band 1108, the second band 1110, the third band 1112, and the fourth band 1114.

In the illustrated example of FIG. 11B, the first process 1144 includes the programmable circuit 812 reordering the cells of the non-accumulated Doppler domain spectrum 1104 to place the cells or signal content from the first band 1108 (for example, across all receivers starting from RX1 to RX4) contiguously followed by the cells or signal content from the second band 1110 and so on to create the vector 1146. In the example of FIG. 11B, a second example process 1148 includes the programmable circuit 812 performing an FFT along the vector 1146 to generate an example TX-RX-FFT-based angle spectrum 1150. To generate the TX-RX-FFT-based angle spectrum 1150, the programmable circuit 812 performs a non-zero padded FFT. A non-zero padded FFT is an FFT where the number of angle bins of the angle spectrum is equal to the length of the input vector which is 16 in the example of FIG. 11B.

In the illustrated example of FIG. 11B, the TX-RX-FFT-based angle spectrum 1150 is referred to as such because the TX-RX-FFT-based angle spectrum 1150 is based on signal content across all receivers and all bands of the non-accumulated Doppler domain spectrum 1104. In the example of FIG. 11B, the TX-RX-FFT-based angle spectrum 1150 includes signal magnitude across angle of reception. The location of peaks in the TX-RX-FFT-based angle spectrum 1150 corresponds to the AOA of a radar signal reflected from an object in the FOV of a radar. Based on the TX-RX-FFT-based angle spectrum 1150, the programmable circuit 812 determines a first example peak 1152 and a second example peak 1154. For example, the first peak 1152 corresponds to a first candidate angle of a first object with respect to a radar and the second peak 1154 corresponds to a first candidate angle of a second object with respect to the radar.

In the illustrated example of FIG. 11B, the processing flow 1142 leverages the circular shift property of an FFT. The circular shift property indicates that circularly shifting a vector at the input of an FFT does not alter the magnitude spectrum of the FFT. Because the vector 1146 on which the FFT is performed at the process 1148 includes the signal content from the entirety of the non-accumulated Doppler domain spectrum 1104, the programmable circuit 812 can only utilize the processing flow 1142 if the virtual antenna array (1) includes only a single row with no gaps and (2) virtual antenna elements arising from each transmitter are contiguously located. An example virtual antenna array 1156 meets the two criteria. For example, the virtual antenna array 1156 corresponds to a radar transceiver IC having three example transmitters 1158 and four example receivers 1160.

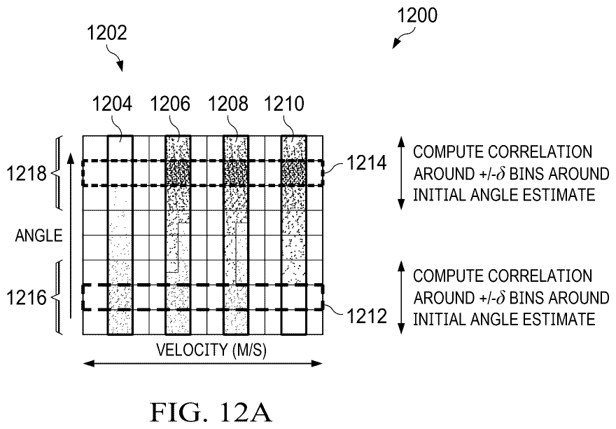

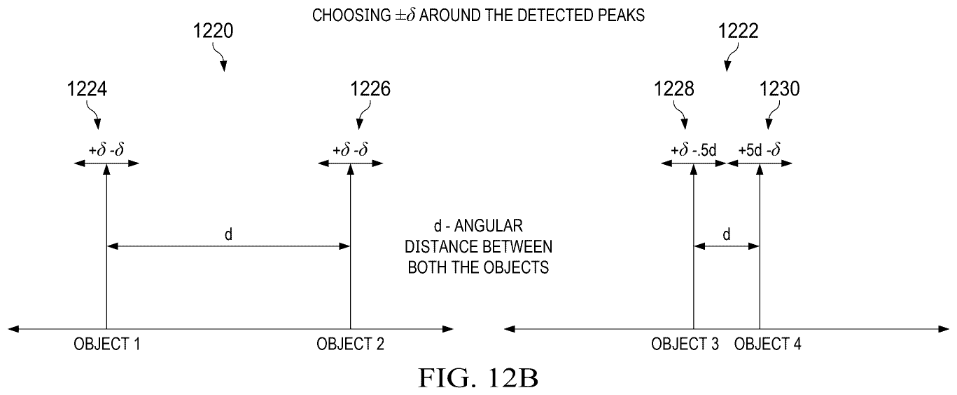

FIG. 12A is a diagram of an example processing flow 1200 to perform transmitter disambiguation for multiple objects at the second process 914 of FIG. 9. For example, the processing flow 1200 includes the programmable circuit 812 performing transmitter disambiguation on an angle Fourier transform (FT) 1202. In the example of FIG. 12A, the angle FT 1202 is a matrix including rows of Doppler domain data corresponding to angle bins. In other words, each row of the angle FT 1202 corresponds to one angle bin and includes Doppler domain data for that angle bin. Also, each column of the angle FT 1202 represents a band of the Doppler domain. For example, the angle FT 1202 includes a first example band 1204, a second example band 1206, a third example band 1208, and a fourth example band 1210.

In the illustrated example of FIG. 12A, the programmable circuit 812 applies coarsely estimated angles of objects to an angle FT to identify angle bins that correspond to the objects. For example, the programmable circuit 812 applies coarsely estimated angles of a first object and a second object to the angle FT 1202. By doing so, the programmable circuit 812 identifies a first example angle bin 1212 of the angle FT 1202 that corresponds to the first object and a second example angle bin 1214 of the angle FT 1202 that corresponds to the second object.

As described above, if there are fewer receivers than the number of angle bins over which the programmable circuit 812 performs the FFT to generate the angle FT 1202, the signal content of the received frame of reflected chirps is spread across more bins in the angle dimension than the number of receivers. As such, there is a risk that some of the angle bins of the angle FT 1202 are corrupted. For example, interference from another object or noise in the received frame of reflected chirps may corrupt the first angle bin 1212 and the second angle bin 1214. Also or alternatively, signal content corresponding to the first object and the second object may be spread across more angle bins than just the first angle bin 1212 and the second angle bin 1214, respectively.

Advantageously, the programmable circuit 812 considers the signal content in a group of angle bins around each of the first angle bin 1212 and the second angle bin 1214 to avoid at least one of noise or interference dominating the Doppler data in an individual angle bin. In the example of FIG. 12A, the programmable circuit 812 evaluates the signal content in a first example group 1216 of angle bins around the first angle bin 1212. Also, the programmable circuit 812 evaluates the signal content in a second example group 1218 of angle bins around the second angle bin 1214.

In the illustrated example of FIG. 12A, the number of angle bins in the first group 1216 and the second group 1218 is based on a threshold value (δ). For example, the first group 1216 includes the first angle bin 1212 and the angle bins that are greater than and less than the first angle bin 1212 by the threshold value (for example, the first angle bin 1212±δ). Also, for example, the second group 1218 includes the second angle bin 1214 and the angle bins that are greater than and less than the second angle bin 1214 by the threshold value (for example, the second angle bin 1214±δ). In the example of FIG. 12A, the threshold value (δ) is one.

In the illustrated example of FIG. 12A, for respective angle bins of the first group 1216, the programmable circuit 812 determines a candidate mapping of transmitters and respective empty bands to the respective angle bins. For example, for each angle bin of the first group 1216, the programmable circuit 812 determines which of the mappings of FIGS. 5A-5D matches the Doppler domain data of the angle bin. Based on candidate mappings for the respective angle bins of the first group 1216, the programmable circuit 812 determines an output mapping of the transmitters and a first empty band to the first angle bin 1212. For example, the programmable circuit 812 determines the output mapping for the first angle bin 1212 as the mathematical mode of the candidate mappings of the respective angle bins of the first group 1216.

In the illustrated example of FIG. 12A, for respective angle bins of the second group 1218, the programmable circuit 812 determines a candidate mapping of transmitters and respective empty bands to the respective angle bins. For example, for each angle bin of the second group 1218, the programmable circuit 812 determines which of the mappings of FIGS. 5A-5D matches the Doppler domain data of the angle bin. Examples of how to determine which mapping matches Doppler domain data are described in commonly assigned U.S. patent application Ser. No. 19/033,036, filed Jan. 21, 2025, entitled “Improved Disambiguation In Doppler Division Multiple-Access Radar,” which is hereby incorporated herein by reference in its entirety as described above. Based on candidate mappings for the respective angle bins of the second group 1218, the programmable circuit 812 determines an output mapping of the transmitters and a first empty band to the second angle bin 1214. For example, the programmable circuit 812 determines the output mapping for the second angle bin 1214 as the mathematical mode of the candidate mappings of the respective angle bins of the second group 1218.

In some examples, the programmable circuit 812 determines the output mapping for the first angle bin 1212 based on weighting different ones of the angle bins in the first group 1216. For example, the programmable circuit 812 weights each angle bin of the first group 1216 in proportion to the magnitude of the corresponding bin of the coarsely estimated angle spectrum (for example, the RX-FFT-based angle spectrum 1120 or the HAR-based angle spectrum 1132 of FIG. 11A). The programmable circuit 812 also non-coherently combines the weighted angle bins of the first group 1216 in each of the first band 1204, the second band 1206, the third band 1208, and the fourth band 1210. As such, the programmable circuit 812 generates a single value for each of the first band 1204, the second band 1206, the third band 1208, and the fourth band 1210 to yield a single angle bin for the first group 1216. Based on the single angle bin, the programmable circuitry 812 determines the output mapping for the first angle bin 1212. In some examples, the programmable circuit 812 performs a similar process to determine the output mapping for the second angle bin 1214. In the example of FIG. 12A, after the programmable circuit 812 determines the output mappings for the first angle bin 1212 and the second angle bin 1214, the programmable circuit 812 uses the output mappings to estimate the velocity and finer-grained AOA of the first object and the second object.

As described above, the number of angle bins in the first group 1216 and the second group 1218 is based on a threshold value (δ). For example, the threshold value (δ) is empirically chosen to achieve a target probability of correctly disambiguating transmitters in the event of band collision. FIG. 12B is a diagram of a first example graph 1220 and a second example graph 1222 illustrating two techniques for choosing the threshold value (δ) of FIG. 12A. In the example of FIG. 12B, the first graph 1220 corresponds to the AOA of a radar signal reflected from a first object and a second object in the FOV of a radar. Also, the second graph 1222 corresponds to the AOA of a radar signal reflected from a third object and a fourth object in the FOV of the radar.

In the illustrated example of FIG. 12B, the first graph 1220 includes a first example peak 1224 representative of the first object and a second example peak 1226 representative of the second object. In the first graph 1220, the angular distance (d) between the first peak 1224 and the second peak 1226 is greater than the threshold value (δ). As such, the programmable circuit 812 used the native threshold value (δ). For example, the programmable circuit 812 uses a threshold value pair of +δ/−δ for the first peak 1224 and a threshold value pair of +δ/−δ for the second peak 1226.

In the illustrated example of FIG. 12B, the second graph 1222 includes a third example peak 1228 representative of the third object and a fourth example peak 1230 representative of the fourth object. In the second graph 1222, the angular distance (d) between the third peak 1228 and the fourth peak 1230 is less than the threshold value (δ). As such, the programmable circuit 812 does not use the native threshold value (δ). For example, the programmable circuit 812 uses a threshold value pair of +δ/−0.5d for the third peak 1228 where the threshold value (δ) corresponds to an exterior threshold value external to the third object and the angular distance (d) corresponds to an interior threshold value between the third object and the fourth object. For the fourth peak 1230, the programmable circuit 812 uses a threshold value pair of +0.5d/−δ where the threshold value (δ) corresponds to an interior threshold value between the third object and the fourth object and the angular distance (d) corresponds to an exterior threshold value external to the fourth object.

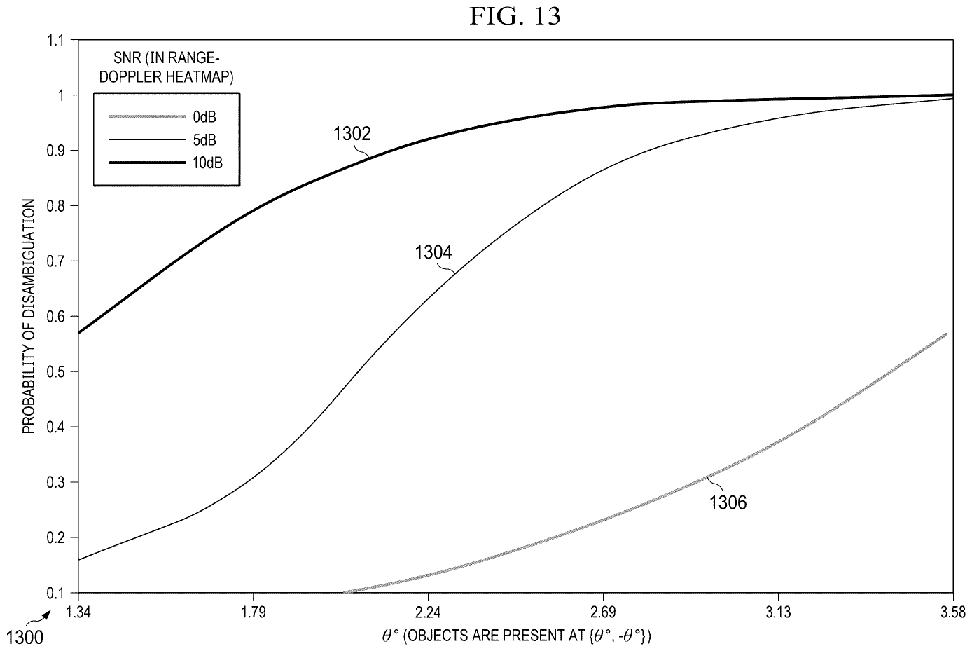

FIG. 13 is a diagram of an example graph 1300 comparing the probability of correctly disambiguating transmitters with non-contiguous empty bands in the presence of band collision as described herein. In the example of FIG. 13, the graph 1300 includes a first example plot 1302, a second example plot 1304, and a third example plot 1306. In the example of FIG. 13, the first plot 1302, the second plot 1304, and the third plot 1306 represent the probability of correctly disambiguating transmitters in the presence of band collision as described herein. In the example of FIG. 13, the first plot 1302, the second plot 1304, and the third plot 1306 correspond to a radar transceiver IC including eight transmitters and eight receivers utilizing non-contiguous empty bands as described in FIG. 6B.

In the illustrated example of FIG. 13, the first plot 1302, the second plot 1304, and the third plot 1306 represent the probability of correctly disambiguating transmitters at different SNRs. For example, the first plot 1302 represent the probability of correctly disambiguating transmitters at an SNR of 10 decibels (dB). Also, the second plot 1304 represent the probability of correctly disambiguating transmitters at an SNR of 5 dB. In the example of FIG. 13, the third plot 1306 represent the probability of correctly disambiguating transmitters at an SNR of 0 dB. In the example of FIG. 13, the SNR corresponding to the first plot 1302, the second plot 1304, and the third plot 1306 are determined as the SNR of the signal in a non-accumulated Doppler domain spectrum such as the non-accumulated Doppler domain spectrum 1104 of FIG. 11A.

As illustrated in FIG. 13, the probability of correctly disambiguating transmitters with non-contiguous empty bands in the presence of band collision increases as the SNR of radar signals increases. Also, at SNRs of 5 and 10 dB, the probability of correctly disambiguating transmitters with non-contiguous empty bands in the presence of band collision approaches one as the angular distance between the multiple objects increases. At an SNR of 0 dB, the probability of correctly disambiguating transmitters with non-contiguous empty bands in the presence of band collision approaches 60% as the angular distance between the multiple objects increases to 3.58°. As such, at high enough SNR (for example, 5-10 dB SNR) and large enough angle of separation between objects (for example, more than 3°), the probability of successfully disambiguating the transmitters is high.

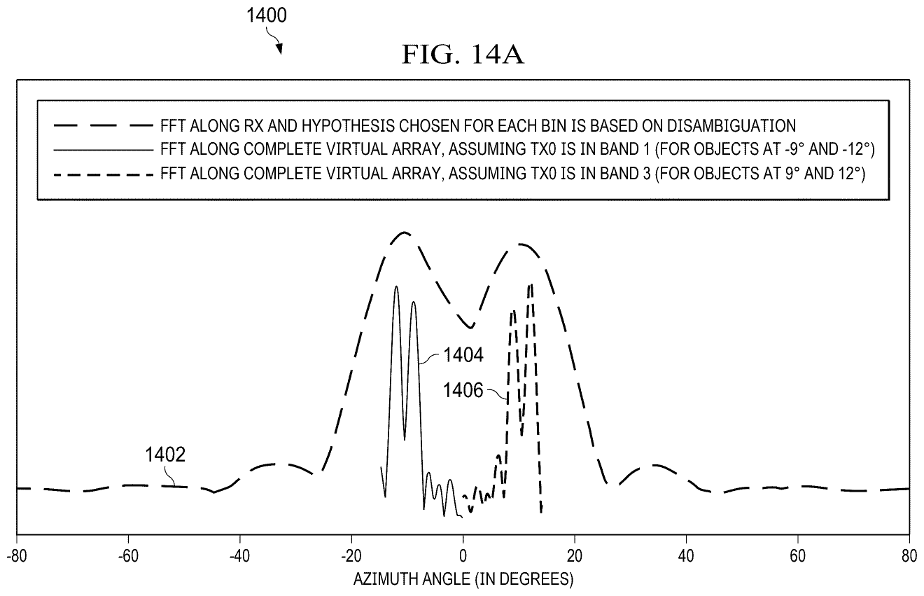

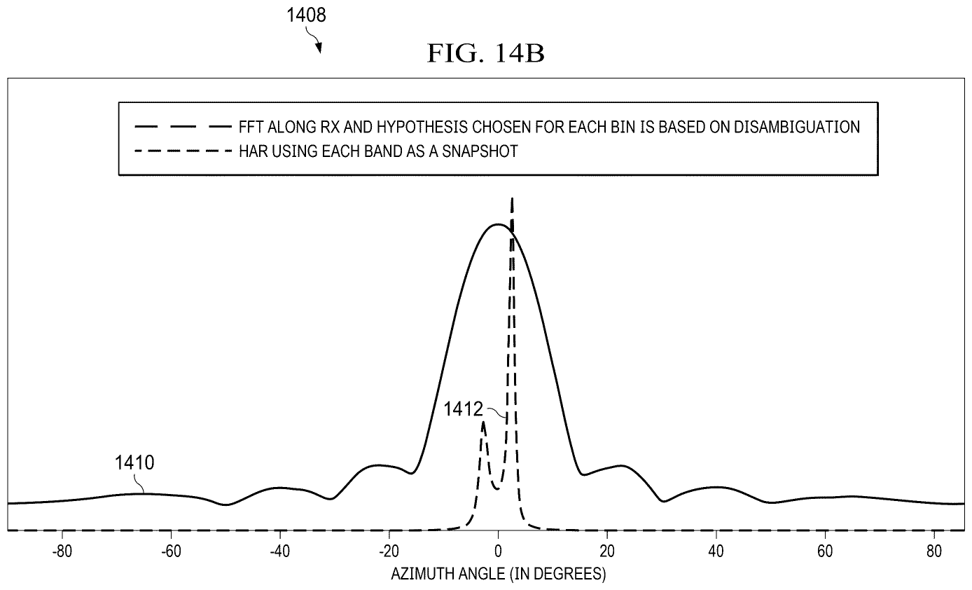

FIG. 14A is a diagram of an example graph 1400 illustrating the estimated angle of objects with respect to the radar transceiver IC 800 for different angle estimation techniques. In the example of FIG. 14A, the graph 1400 includes a first example plot 1402, a second example plot 1404, and a third example plot 1406. In the example of FIG. 14A, the first plot 1402 represents the angle spectrum as determined by FFT-based coarse angle estimation. As illustrated in FIG. 14A, the first plot 1402 includes two main lobes corresponding to two groups of objects that are very close in angle (for example, within 3° of one another). Even if FFT-based coarse angle estimation does not have sufficient resolution to distinguish between multiple objects within a group, the programmable circuit 812 can utilize FFT-based coarse angle estimation for disambiguation in some examples.

Provided that (1) the objects in each group have the same velocity (for example, the matching mappings of FIGS. 5A-5D are the same for each object in a group) and (2) the groups of objects are well separated in the angle domain relative to the native resolution of the receivers 810₁-810_{N}, the programmable circuit 812 can utilize FFT-based coarse angle estimation for disambiguation. For example, such scenarios may occur on highways where multiple cars are travelling at the same velocity and are at the same distance from a radar circuit, such as vehicles travelling the same direction side-by-side in adjacent lanes of a roadway. In the example of FIG. 14A, the two groups of objects are centered around −10° and +10° with each group having two objects at (−9°, −12°) and (9°, 12°), respectively.

As such, the programmable circuit 812 can utilize FFT-based coarse angle estimation for disambiguation. After the programmable circuit 812 performs FFT-based coarse angle estimation to determine the angles of the two groups of objects with respect to the radar transceiver IC 800, the programmable circuit 812 disambiguates the transmitters 804₁-804_{N} as described herein (for example, according to the mappings of FIGS. 5A-5D). Based on disambiguation of the transmitters 804₁-804_{N}, the programmable circuit 812 can compute an angle FT based on the full virtual array of the radar transceiver IC 800 (for example, using the transmitters 804₁-804_{N} and the receivers 810₁-810_{N}).

For example, the programmable circuit 812 performs an angle FT on the radar data based on the full virtual array. Because each group of objects can have a different mapping, the programmable circuit 812 performs an angle FT based on the full virtual array independently for each group of objects. In the example of FIG. 14A, The programmable circuit 812 concatenates the valid regions of the generated angle spectrums for each group (represented by the second plot 1404 and the third plot 1406, respectively) to create a full spectrum as shown in FIG. 14A.

FIG. 14B is a diagram of an example graph 1408 illustrating the estimated angle of objects with respect to the radar transceiver IC 800 for different angle estimation techniques. In the example of FIG. 14B, the graph 1408 includes a first example plot 1410 and a second example plot 1412. In the example of FIG. 14B, the first plot 1410 represents the angle spectrum as determined by FFT-based coarse angle estimation. As illustrated in FIG. 14B, the first plot 1402 includes one main lobe corresponding to a group of objects that are very close in angle (for example, within 5° of one another). For example, the group of objects is centered around 0° and has two objects at −2.5° and 2.5°. However, the first plot 1402 does not distinguish between the two objects of the group.

Advantageously, the programmable circuit 812 can utilize HAR algorithm-based coarse angle estimation for disambiguation. For example, the second plot 1412 represents the angle spectrum as determined by HAR algorithm-based coarse angle estimation. After the programmable circuit 812 performs HAR algorithm-based coarse angle estimation to determine the angles of the objects with respect to the radar transceiver IC 800, the programmable circuit 812 disambiguates the transmitters 804₁-804_{N} as described herein (for example, according to the mappings of FIGS. 5A-5D). Based on disambiguation of the transmitters 804₁-804_{N}, the programmable circuit 812 can compute an angle FT based on the full virtual array of the radar transceiver IC 800 (for example, using the transmitters 804₁-804_{N} and the receivers 810₁-810_{N}).

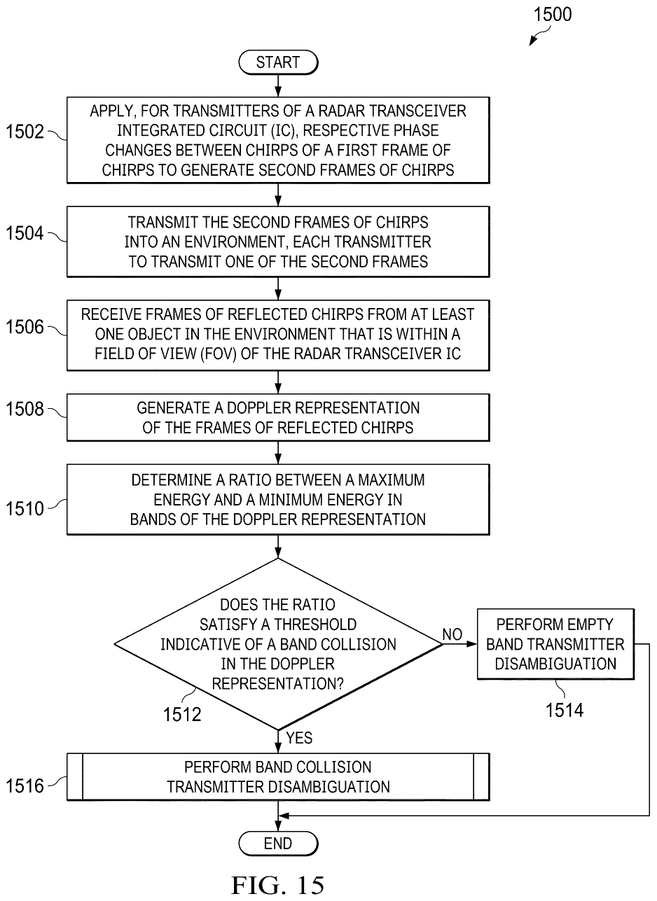

FIG. 15 is a flowchart representative of at least one of example machine-readable instructions or example operations 1500 that may be at least one of executed, instantiated, or performed using an example programmable circuitry implementation of the radar transceiver IC 800 of FIG. 8. The at least one of the example machine-readable instructions or the example operations 1500 of FIG. 15 begin at block 1502, at which the phase shifters 814₁-814_{N} apply, for the transmitters 804₁-804_{N} of the radar transceiver IC 800, respective phase changes between chirps of a first frame of chirps to generate second frames of chirps. For example, each of the phase shifters 814₁-814_{N} applies a phase change between the chirps of the first frame to generate a second frame at each of the phase shifters 814₁-814_{N}.

In the illustrated example of FIG. 15, at block 1504, the transmitters 804₁-804_{N} transmit the second frames of chirps into an environment. For example, the PAs 816₁-816_{N} amplify the second frames and transmit the second frames of chirps into the environment via the transmit antennas 806₁-806_{N}. In the example of FIG. 15, each of the transmitters 804₁-804_{N} transmits one of the second frames. At block 1506, the receivers 810₁-810_{N} receive frames of reflected chirps from at least one object in the environment that is within a field of view of the radar transceiver IC 800. For example, multiple objects may be in the field of view of the radar transceiver IC 800.

In the illustrated example of FIG. 15, at block 1508, the programmable circuit 812 generates a Doppler representation of the frames of reflected chirps. In the example of FIG. 15, the programmable circuit 812 generates a Doppler representation for the frames of reflected chirps received at each of the receive antennas 808₁-808_{N}. For example, the programmable circuit 812 performs a range FFT on the received frame of reflected chirps provided by each of the receivers 810₁-810_{N}. The programmable circuit 812 also performs a Doppler FFT on the results of the range FFTs to generate a Doppler representation of the received frame of reflected chirps provided by each of the receivers 810₁-810_{N}. In the example of FIG. 15, the programmable circuit 812 accumulates the Doppler representations for each of the receivers 810₁-810_{N} across the receive antennas 808₁-808_{N} to generate a single Doppler representation.

In the illustrated example of FIG. 15, at block 1510, the programmable circuit 812 determines a ratio between a maximum energy and a minimum energy in bands of the Doppler representation. As described above, each of the bands of the Doppler representation include multiple columns of Doppler data. To determine the ratio, the programmable circuit 812 determines a ratio between a maximum energy and a minimum energy in the corresponding column of each of the bands that includes the signal content of interest (for example, column a, column b, column c, and column d in FIG. 11A). At block 1512, the programmable circuit 812 determines whether the ratio satisfies a threshold indicative of a band collision in the Doppler representation. For example, the programmable circuit 812 determines whether the ratio is less than the threshold. Responsive to (for example, based on) the ratio not satisfying the threshold (block 1512: NO), the at least one of the machine-readable instructions or the operations 1500 proceed to block 1514. For example, responsive to the ratio not satisfying the threshold, the programmable circuit 812 determines that a band collision is not present. As such, at block 1514, the programmable circuit 812 performs empty band transmitter disambiguation.

For example, for potential mappings of the transmitters 804₁-804_{N} and at least one empty band to the Doppler representation, the programmable circuit 812 computes sums of energy in respective bands of the Doppler representation in which the object is to be represented according to the potential mappings. Also, the programmable circuit 812 selects, as a candidate mapping of the transmitters 804₁-804_{N} and the at least one empty band to the Doppler representation, one of the potential mappings that has a largest sum of energy among the potential mappings. Based on the candidate mapping, the programmable circuit 812 can disambiguate the transmit antennas 806₁-808_{N} and determine a velocity of the object detected in the environment.

In the illustrated example of FIG. 15, responsive to (for example, based on) the ratio satisfying the threshold (block 1512: YES), the at least one of the machine-readable instructions or the operations 1500 proceed to block 1516. For example, responsive to the ratio satisfying the threshold, the programmable circuit 812 determines that a band collision is present. As such, at block 1516, the programmable circuit 812 performs band collision transmitter disambiguation.

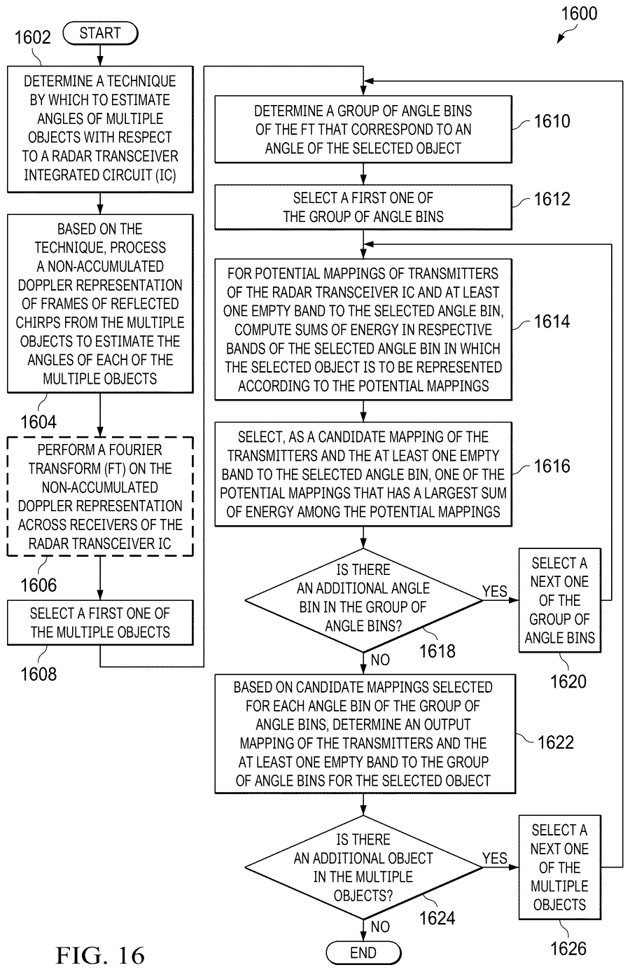

FIG. 16 is a flowchart representative of at least one of example machine-readable instructions or example operations 1600 that may be at least one of executed, instantiated, or performed using an example programmable circuitry implementation of the radar transceiver IC 800 of FIG. 8 to perform band collision transmitter disambiguation. The at least one of the example machine-readable instructions or the example operations 1600 of FIG. 16 begin at block 1602, at which the programmable circuit 812 determines a technique by which to estimate angles of multiple objects with respect to the radar transceiver IC 800. For example, the programmable circuit 812 can estimate angles of multiple objects using FFT-based coarse angle estimation or HAR algorithm-based coarse angle estimation.

In some examples, the programmable circuit 812 is hard coded to estimate angles of multiple objects using one of FFT-based coarse angle estimation or HAR algorithm-based coarse angle estimation. Also or alternatively, the programmable circuit 812 determines whether to utilize FFT-based coarse angle estimation or HAR algorithm-based coarse angle estimation on-the-fly. At block 1604, based on the technique, the programmable circuit 812 processes a non-accumulated Doppler representation of frames of reflected chirps from the multiple objects to estimate the angles of each of the multiple objects.

For FFT-based coarse angle estimation, the programmable circuit 812 performs a FT on the non-accumulated Doppler representation of the frames of reflected chirps across the receivers 810₁-810_{N}. Also, the programmable circuit 812 averages the FT across bands of the non-accumulated Doppler representation to determine an output vector including signal magnitude across angle of reception. As described above, averaging the FT across bands includes accumulating the Doppler data in one of the columns per band of the FT. Based on the output vector, the programmable circuit 812 estimates the angles of each of the multiple objects. For example, the programmable circuit 812 estimates a first angle of a first object and a second angle of a second object.

For HAR algorithm-based coarse angle estimation, the programmable circuit 812 processes the non-accumulated Doppler representation of the frames of reflected chirps according to a high angle resolution algorithm to determine an output vector including signal magnitude across angle of reception. For example, the programmable circuit 812 processes the non-accumulated Doppler representation of the frames of reflected chirps according to a MUSIC algorithm to determine the output vector. Based on the output vector, the programmable circuit 812 estimates the angles of each of the multiple objects. For example, the programmable circuit 812 estimates a first angle of a first object and a second angle of a second object.

In some examples, the programmable circuit 812 performs a FT on the non-accumulated Doppler representation across the receivers 810₁-810_{N} of the radar transceiver IC 800 at block 1606. For example, if the programmable circuit 812 estimated the angles of each of the multiple objects utilizing HAR algorithm-based coarse angle estimation, then, during coarse angle estimation, the programmable circuit 812 may not have performed an FT on the non-accumulated Doppler representation of the frames of reflected chirps across the receivers 810₁-810_{N}. As described above, in FIG. 12A, the programmable circuit 812 performs transmitter disambiguation on an angle FT (also referred to as an FT performed across receivers of a radar transceiver IC). Thus, if the programmable circuit 812 estimated the angles of each of the multiple objects utilizing HAR algorithm-based coarse angle estimation, then the programmable circuit 812 performs the FT on the non-accumulated Doppler representation across the receivers 810₁-810_{N} at block 1606 to facilitate transmitter disambiguation. Alternatively, if the programmable circuit 812 estimated the angles of each of the multiple objects utilizing FFT-based coarse angle estimation, then the programmable circuit 812 can utilize the FT generated to perform FFT-based coarse angle estimation.

As described above, the programmable circuit 812 determines an output vector including signal magnitude across angle of reception to estimate the angles of each of the multiple objects. For example, the programmable circuit 812 processes the output vector according to a peak detection techniques such as CFAR detection or Local Maxima detection to identify the angles of each of the multiple objects. By applying the identified angles to the FT of the non-accumulated Doppler representation, the programmable circuit 812 identifies angle bins of the FT corresponding to the multiple objects. For example, the programmable circuit 812 identifies a first angle bin that corresponds to a first object and a second angle bin that corresponds to a second object. At block 1608, the programmable circuit 812 selects a first one of the multiple objects to be analyzed. For example, the programmable circuit 812 selects a first angle bin corresponding to the first one of the multiple objects.

In the illustrated example of FIG. 16, at block 1610, the programmable circuit 812 determines a group of angle bins of the FT that correspond to an angle of the selected object. For example, the programmable circuit 812 determines a group of angle bins that are a threshold (δ) value away (for example, ±δ) from the selected angle bin in the angle domain. In the example of FIG. 16, the group of angle bins includes the angle bin corresponding to the selected object. Also, in the example of FIG. 16, for respective angle bins of the group, the programmable circuit 812 determines a candidate mapping of the transmitters 804₁-804_{N} and respective empty bands to the respective angle bins. As such, the programmable circuit 812 can perform Doppler disambiguation for a plurality of angle bins included in the group of angle bins.

For example, at block 1612, the programmable circuit 812 selects a first one of the group of angle bins. At block 1614, for potential mappings of the transmitters 804₁-804_{N} of the radar transceiver IC 800 and at least one empty band to the selected angle bin, the programmable circuit 812 computes sums of energy in respective bands of the selected angle bin in which the object is to be represented according to the potential mappings. At block 1616, the programmable circuit 812 selects, as a candidate mapping of the transmitters 804₁-804_{N} and the at least one empty band to the selected angle bin, one of the potential mappings that has a largest sum of energy among the potential mappings.

In the illustrated example of FIG. 16, at block 1618, the programmable circuit 812 determines whether there is an additional angle bin in the group of angle bins. Responsive to (for example, based on) the programmable circuit 812 determining that there is an additional angle bin in the group of angle bins (block 1618: YES), the at least one of the machine-readable instructions or the operations 1600 proceed to block 1620. At block 1620, the programmable circuit 812 selects a next one of the group of angle bins. Responsive to (for example, based on) the programmable circuit 812 determining that there is not an additional angle bin in the group of angle bins (block 1618: NO), the at least one of the machine-readable instructions or the operations 1600 proceed to block 1622.

In the illustrated example of FIG. 16, at block 1622, based on the candidate mappings selected for each angle bin of the group of angle bins, the programmable circuit 812 determines an output mapping of the transmitters 804₁-804_{N} and the at least one empty band to the group of angle bins for the selected object. For example, the programmable circuit 812 determines the output mapping as a mathematical mode of the candidate mappings of the respective angle bins of the group of angle bins. Upon determining the output mapping of the transmitters 804₁-804_{N} and at least one empty band to the group of angle bins for the selected object, the programmable circuit 812 can determine a velocity of the object corresponding to the group of angle bins.

In the illustrated example of FIG. 16, at block 1624, the programmable circuit 812 determines whether there is an additional object in the multiple objects. For example, the programmable circuit 812 determines whether there is an additional peak in the FT of the non-accumulated Doppler representation. Responsive to (for example, based on) the programmable circuit 812 determining that there is an additional object in the multiple objects (block 1624 YES), the at least one of the machine-readable instructions or the operations 1600 proceed to block 1626. At block 1626, the programmable circuit 812 selects a next one of the multiple objects. Subsequently, the machine-readable instructions or the operations 1600 repeat blocks 1610-1624 for the next one of the multiple objects.

As such, the programmable circuit 812 determines output mappings of the transmitters 804₁-804_{N} and at least one empty band to each of the multiple objects. For example, the programmable circuit 812 determines a first mapping of the transmitters 804₁-804_{N} and a first empty band to a first angle bin corresponding to a first object and a second mapping of the transmitters 8041804N and a second empty band to a second angle bin corresponding to a second object. In the example of FIG. 16, responsive to (for example, based on) the programmable circuit 812 determining that there is not an additional object in the multiple objects (block 1624: NO), the at least one of the machine-readable instructions or the operations 1600 terminate.

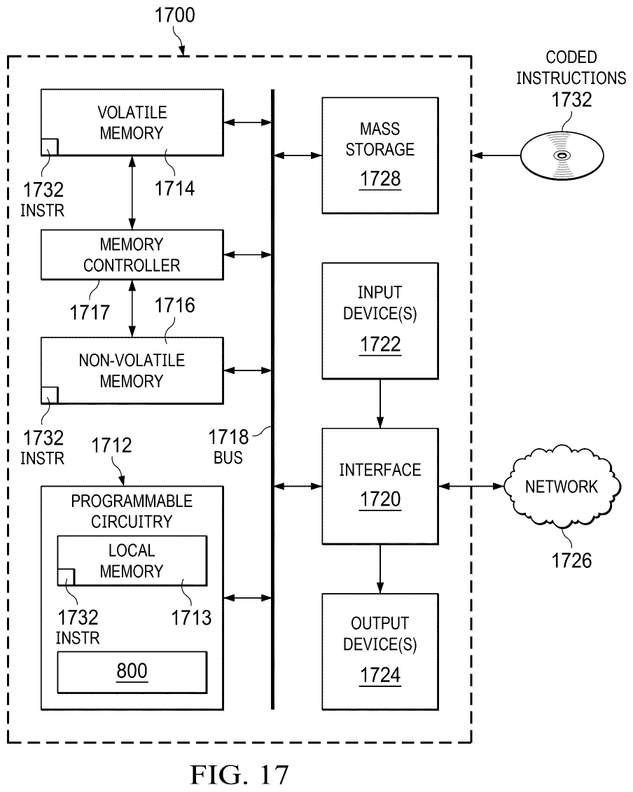

FIG. 17 is a block diagram of an example programmable circuitry platform 1700 structured to one or a combination of execute or instantiate one or more of the example machine-readable instructions or the example operations of FIGS. 15 and 16 to implement the radar transceiver IC 800 of FIG. 8. The programmable circuitry platform 1700 can be, for example, a personal computer, a workstation, a self-learning machine (for example, a neural network), a mobile device (for example, a cell phone, a smart phone, a tablet such as an iPad™), a digital video recorder, a gaming console, a headset (for example, an augmented reality (AR) headset, a virtual reality (VR) headset, etc.) or other wearable device, a vehicle, an industrial machine, or any other type of computing or electronic device.

The programmable circuitry platform 1700 of the illustrated example includes programmable circuitry 1712. The programmable circuitry 1712 of the illustrated example is hardware. For example, the programmable circuitry 1712 can be implemented by one or more integrated circuits, logic circuits, FPGAs, microprocessors, CPUs, hardware accelerators, GPUs, DSPs, or microcontrollers from any desired family or manufacturer. The programmable circuitry 1712 may be implemented by one or more semiconductor based (for example, silicon based) devices. In this example, the programmable circuitry 1712 implements the radar transceiver IC 800.

The programmable circuitry 1712 of the illustrated example includes a local memory 1713 (for example, a cache, registers, etc.). The programmable circuitry 1712 of the illustrated example is in communication with main memory 1714, 1716, which includes a volatile memory 1714 and a non-volatile memory 1716, by a bus 1718. The volatile memory 1714 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1716 may be implemented by one or a combination of flash memory or any other desired type of memory device. Access to the main memory 1714, 1716 of the illustrated example is controlled by a memory controller 1717. In some examples, the memory controller 1717 may be implemented by one or more integrated circuits, logic circuits, microcontrollers from any desired family or manufacturer, or any other type of circuitry to manage the flow of data going to and from the main memory 1714, 1716.

The programmable circuitry platform 1700 of the illustrated example also includes interface circuitry 1720. The interface circuitry 1720 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1722 are connected to the interface circuitry 1720. The input device(s) 1722 permit(s) a user (for example, a human user, a machine user, etc.) to enter one of or a combination of data or commands into the programmable circuitry 1712. The input device(s) 1722 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1724 are also connected to the interface circuitry 1720 of the illustrated example. The output device(s) 1724 can be implemented, for example, by one of or a combination of display devices (for example, a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1720 of the illustrated example, thus, includes one of or a combination of a graphics driver card, a graphics driver chip, or graphics processor circuitry such as a GPU.

The interface circuitry 1720 of the illustrated example also includes a communication device such as one of or a combination of a transmitter, a receiver, a transceiver, a modem, a residential gateway, a wireless access point, or a network interface to facilitate exchange of data with external machines (for example, computing devices of any kind) by a network 1726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1700 of the illustrated example also includes one or more mass storage discs or devices 1728 to store one or more of firmware, software, or data. Examples of such mass storage discs or devices 1728 include one or more magnetic storage devices (for example, floppy disk, drives, HDDs, etc.), optical storage devices (for example, Blu-ray disks, CDs, DVDs, etc.), RAID systems, or solid-state storage discs or devices such as flash memory devices and SSDs.

The machine-readable instructions 1732, which may be implemented by the machine-readable instructions of FIGS. 15 and 16, may be stored in one of or a combination of the mass storage device 1728, in the volatile memory 1714, in the non-volatile memory 1716, or on at least one non-transitory computer-readable storage medium such as a CD or DVD which may be removable.

While an example manner of implementing the radar circuits 102_{A}-102_{H} of FIG. 1 is illustrated in FIG. 8, one or more of the elements, processes, or devices illustrated in FIG. 8 may be combined, divided, re-arranged, omitted, eliminated, or implemented in any other way. Further, the example chirp synthesizer circuit 802, the example transmitters 804₁-804_{N}, the example transmit antennas 806₁-806_{N}, the example receive antennas 808₁-808_{N}, the example receivers 810₁-810_{N}, the example programmable circuit 812, the example phase shifters 814₁-814_{N}, the example PAs 816₁-816_{N}, the example LNAs 818₁-818_{N}, the example mixers 820₁-820_{N}, the example ADCs 822₁-822_{N}, or, more generally, the example radar transceiver IC 800 of FIG. 8, may be implemented by hardware alone or by hardware in combination with software and firmware. Thus, for example, any of the example chirp synthesizer circuit 802, the example transmitters 804₁-804_{N}, the example transmit antennas 806₁-806_{N}, the example receive antennas 808₁-808_{N}, the example receivers 810₁-810_{N}, the example programmable circuit 812, the example phase shifters 814₁-814_{N}, the example PAs 816₁-816_{N}, the example LNAs 818₁-818_{N}, the example mixers 820₁-820_{N}, the example ADCs 822₁-822_{N}, or, more generally, the example radar transceiver IC 800, could be implemented by programmable circuitry in combination with one or more machine-readable instructions (for example, firmware or software), processor circuitry, analog circuit(s), digital circuit(s), logic circuit(s), programmable processor(s), programmable microcontroller(s), hardware accelerator(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example radar transceiver IC 800 of FIG. 8 may include one or more elements, processes, or devices in addition to, or instead of, those illustrated in FIG. 8 or may include more than one of any or all of the illustrated elements, processes, and devices.

Flowchart(s) representative of example machine-readable instructions, which may be executed by programmable circuitry to at least one of implement or instantiate the radar transceiver IC 800 of FIG. 8 or representative of example operations which may be performed by programmable circuitry to at least one of implement or instantiate the radar transceiver IC 800 of FIG. 8, are shown in FIGS. 15 and 16. The machine-readable instructions may be one or more executable programs or portion(s) of one or more executable programs for execution by programmable circuitry such as the programmable circuitry 1712 shown in the example programmable circuitry platform 1700 described below in connection with FIG. 17 and may be one or more function(s) or portion(s) of functions to be performed by the example programmable circuitry (for example, an FPGA). In some examples, an operation, a task, etc., is carried out or performed in an automated manner in the real-world responsive to the machine-readable instructions. As used herein, “automated” means without human involvement.

The program may be embodied in instructions (for example, at least one of software or firmware) stored on one or more non-transitory computer-readable or machine-readable storage medium such as one of or a combination of cache memory, a magnetic-storage device or disk (for example, a floppy disk, a Hard Disk Drive (HDD), etc.), an optical-storage device or disk (for example, a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (for example, electrically erasable programmable read-only memory (EEPROM), flash memory, etc.), volatile memory (for example, Random Access Memory (RAM) of any type, etc.), or any other storage device or storage disk. The instructions of at least one of the non-transitory computer-readable medium or the machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (for example, a server and a client hardware device). For example, the client hardware device may be implemented by an endpoint client hardware device (for example, a hardware device associated with at least one of a human or a machine user) or an intermediate client hardware device gateway (for example, a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 15 and 16, many other methods of implementing the example radar transceiver IC 800 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (for example, processor circuitry, discrete analog circuitry, integrated analog circuitry, discrete digital circuitry, integrated digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (for example, a single-core processor (for example, a single core CPU), a multi-core processor (for example, a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include at least one of one or more CPUs or one or more FPGAs located in the same package (for example, the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine-readable instructions as described herein may be stored as data (for example, computer-readable data, machine-readable data, one or more bits (for example, one or more computer-readable bits, one or more machine-readable bits, etc.), a bitstream (for example, a computer-readable bitstream, a machine-readable bitstream, etc.), etc.) or a data structure (for example, as portion(s) of instructions, code, representations of code, etc.) that may be utilized to create, manufacture, or produce machine-executable instructions. For example, the machine-readable instructions may be fragmented and stored on one or more storage devices, disks or computing devices (for example, servers) located at the same or different locations of a network or collection of networks (for example, in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, where the parts when decrypted, decompressed, or combined form a set of one or more computer-executable or machine-executable instructions that implement one or more functions or operations that may together form a program such as that described herein.

In another example, the machine-readable instructions may be stored in a state in which they may be read by programmable circuitry, but require addition of a library (for example, a dynamic link library (DLL)), a software development kit (SDK), an application programming interface (API), etc., in order to execute the machine-readable instructions on a particular computing device or other device. In another example, the machine-readable instructions may need to be configured (for example, settings stored, data input, network addresses recorded, etc.) before the machine-readable instructions or the corresponding program(s) can be executed in whole or in part. Thus, machine-readable, computer-readable, or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, etc.

As mentioned above, the example operations of FIGS. 15 and 16 may be implemented using executable instructions (such as computer-readable or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (for example, for extended time periods, permanently, for brief instances, for temporarily buffering, for caching of the information). As used herein, the terms “non-transitory computer-readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer-readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer-readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (for example, comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (for example, “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, for example, the same entity or object. Also, although individual features may be included in different examples or claims, these may possibly be combined, and the inclusion in different examples or claims does not imply that a combination of features is at least one of not feasible or advantageous.

As used herein, connection references (for example, attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the description (for example, within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses one of or a combination of direct communication or indirect communication through one or more intermediary components, and does not require direct physical (for example, wired) communication or constant communication, but rather also includes selective communication at least one of periodic intervals, scheduled intervals, aperiodic intervals, or one-time events.

As used herein, “programmable circuitry” may include (i) one or more special purpose electrical circuits (for example, an application specific circuit (ASIC)) structured to perform specific operation(s) and including one or more semiconductor-based logic devices (for example, electrical hardware implemented by one or more transistors), or (ii) one or more general purpose semiconductor-based electrical circuits programmable with instructions to perform one or more specific functions(s) or operation(s) and including one or more semiconductor-based logic devices (for example, electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (for example, one or more FPGAs, one or more CPUs, one or more GPUs, one or more NPUs, one or more DSPs, etc., and any combination(s) thereof), and orchestration technology (for example, application programming interface(s) (API(s)) that may assign computing task(s) to whichever one(s) of the multiple types of programmable circuitry is/are suited and available to perform the computing task(s).

As used herein integrated circuit/circuitry may be one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (for example, at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as at least one of one or more voltage sources or one or more current sources) may instead include only the semiconductor elements within a single physical device (for example, at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. As used herein, “about,” “approximately,” and “substantially” modify their subjects/values to recognize the potential presence of variations that occur in real world applications. For example, “about,” “approximately,” and “substantially” may modify dimensions or values that may not be exact due to at least one of manufacturing tolerances or other real-world imperfections. Unless otherwise stated, “about,” “approximately,” or “substantially” preceding a value means+/−10 percent of the stated value, or, if the value is zero, a reasonable range of values around zero.

Modifications are possible in the examples described, and other examples are possible, within the scope of the claims.

From the foregoing, it will be appreciated that example systems, apparatus, articles of manufacture, and methods have been described that disambiguate band collisions in DDMA systems. For example, described systems, apparatus, articles of manufacture, and methods improve object detection by distinguishing between objects that are close in angle (for example, less than five degrees apart) when band collision occurs. Described systems, apparatus, articles of manufacture, and methods improve the efficiency of using a computing device implementing examples described herein by improving the safety of a vehicle including the computing device. Described systems, apparatus, articles of manufacture, and methods are also directed to one or more improvement(s) in the operation of a machine such as a computer or other electronic, electromechanical, or mechanical device.

What is claimed is:

1. A device comprising:
a memory configurable to store radar data; and
a programmable circuit coupled to the memory and configurable to:
estimate a first angle of a first object using the radar data;
estimate a second angle of a second object using the radar data;
select a first angle bin and a second angle bin using the estimated first angle and the estimated second angle;
perform Doppler disambiguation for the first angle bin; and
perform Doppler disambiguation for the second angle bin.

2. The device of claim 1, wherein to perform Doppler disambiguation for the first angle bin, the programmable circuit is configurable to perform Doppler disambiguation for a plurality of angle bins including the first angle bin.

3. The device of claim 1, wherein the programmable circuit is configurable to process a Doppler representation of the radar data to estimate the first angle and the second angle.

4. The device of claim 1,
wherein the radar data represents frames of reflected chirps from the first object and the second object, and
wherein the first angle bin corresponds to the first object, and the second angle bin corresponds to the second object.

5. The device of claim 1, wherein to perform Doppler disambiguation for the first angle bin and the second angle bin, the programmable circuit is configurable to determine a first mapping of transmitters and a first empty band to the first angle bin and a second mapping of the transmitters and a second empty band to the second angle bin.

6. The device of claim 1,
wherein the radar data represents frames of reflected chirps from the first object and the second object, and
wherein to estimate the first angle and the second angle, the programmable circuit is configurable to:
perform a Fourier transform (FT) on a Doppler representation of the frames of reflected chirps, the FT performed across receivers,
average the FT across bands of the Doppler representation to determine an output vector including signal magnitude across angle of reception, and
based on the output vector, estimate the first angle and the second angle.

7. The device of claim 1,
wherein the radar data represents frames of reflected chirps from the first object and the second object, and
wherein to estimate the first angle and the second angle, the programmable circuit is configurable to:
process a Doppler representation of the frames of reflected chirps according to a high angle resolution algorithm to determine an output vector including signal magnitude across angle of reception, and
based on the output vector, estimate the first angle and the second angle.

8. The device of claim 1,
wherein the radar data represents frames of reflected chirps from the first object and the second object, and
wherein the programmable circuit is configurable to:
determine a ratio between a maximum energy and a minimum energy in bands of a Doppler representation of the frames of reflected chirps, and
based on the ratio satisfying a threshold indicative of a band collision in the Doppler representation, process the Doppler representation to estimate the first angle and the second angle.

9. The device of claim 1,
wherein the radar data represents frames of reflected chirps from the first object and the second object, and
wherein to perform Doppler disambiguation for the first angle bin, the programmable circuit is configurable to:
based on the estimated first angle, determine a group of angle bins of a Fourier transform (FT) of a Doppler representation of the frames of reflected chirps that correspond to the first object, the group including the first angle bin, the FT performed across radar receivers,
for respective angle bins of the group, determine a candidate mapping of transmitters and respective empty bands to the respective angle bins, and
based on candidate mappings for the respective angle bins, determine an output mapping of the transmitters and a first empty band to the first angle bin.

10. The device of claim 9, wherein the programmable circuit is configurable to determine the output mapping as a mathematical mode of the candidate mappings of the respective angle bins.

11. The device of claim 1, wherein the device includes a Doppler division multiple-access radar device.

12. A method comprising:
estimating a first angle of a first object using radar signals;
estimating a second angle of a second object using the radar signals;
selecting a first angle bin and a second angle bin using the estimated first angle and the estimated second angle; and
performing Doppler disambiguation for the first angle bin; and
performing Doppler disambiguation for the second angle bin.

13. The method of claim 12, wherein performing Doppler disambiguation for the first angle bin comprises performing Doppler disambiguation for a plurality of angle bins including the first angle bin.

14. The method of claim 12,
wherein the radar signals include frames of reflected chirps from the first object and the second object, and
wherein estimating the first angle and the second angle comprises:
performing a Fourier transform (FT) on a Doppler representation of the frames of reflected chirps, the FT performed across receivers,
averaging the FT across bands of the Doppler representation to determine an output vector including signal magnitude across angle of reception, and
based on the output vector, estimating the first angle and the second angle.

15. The method of claim 12,
wherein the radar signals include frames of reflected chirps from the first object and the second object, and
wherein estimating the first angle and the second angle comprises:
processing a Doppler representation of the frames of reflected chirps according to a high angle resolution algorithm to determine an output vector including signal magnitude across angle of reception, and
based on the output vector, estimating the first angle and the second angle.

16. The method of claim 12,
wherein the radar signals include frames of reflected chirps from the first object and the second object, and
wherein the method comprises:
determining a ratio between a maximum energy and a minimum energy in bands of a Doppler representation of the frames of reflected chirps, and
based on the ratio satisfying a threshold indicative of a band collision in the Doppler representation, processing the Doppler representation to estimate the first angle and the second angle.

17. A system comprising:
a plurality of radar receivers configurable to receive radar signals reflected from a first object and a second object; and
a programmable circuit coupled to the plurality of radar receivers and configurable to:
estimate a first angle of the first object using the radar signals;
estimate a second angle of the second object using the radar signals;
select a first angle bin and a second angle bin using the estimated first angle and the estimated second angle;
perform Doppler disambiguation for the first angle bin; and
perform Doppler disambiguation for the second angle bin.

18. The system of claim 17, wherein to perform Doppler disambiguation for the first angle bin, the programmable circuit is configured to perform Doppler disambiguation for a plurality of angle bins including the first angle bin.

19. The system of claim 17,
wherein the radar signals include frames of reflected chirps from the first object and the second object, and
wherein to estimate the first angle and the second angle, the programmable circuit is configurable to:
perform a Fourier transform (FT) on a Doppler representation of the frames of reflected chirps, the FT performed across the plurality of radar receivers,
average the FT across bands of the Doppler representation to determine an output vector including signal magnitude across angle of reception, and
based on the output vector, estimate the first angle and the second angle.

20. The system of claim 17,
wherein the radar signals include frames of reflected chirps from the first object and the second object, and
wherein to estimate the first angle and the second angle, the programmable circuit is configurable to:
process a Doppler representation of the frames of reflected chirps according to a high angle resolution algorithm to determine an output vector including signal magnitude across angle of reception, and
based on the output vector, estimate the first angle and the second angle.
